(19) United States
(12) Patent Application Publication
(10) Pub. No.: US 2026/0099071 A1
(43) Pub. Date: Apr. 9, 2026

(54) DISPLAY APPARATUS INCLUDING SWITCHABLE INFINITY MIRROR STRUCTURE AND EDGE-TYPE BACKLIGHT

(71) Applicant: ALPS ALPINE CO., LTD., Tokyo (JP)

(72) Inventor: Takashi YASUMOTO, Fukushima (JP)

(21) Appl. No.: 19/416,545

(22) Filed: Dec. 11, 2025

Related U.S. Application Data
(63) Continuation of application No. PCT/JP2024/008192, filed on Mar. 5, 2024.

(30) Foreign Application Priority Data
Jul. 12, 2023 (JP) 2023-114744

(51) Int. Cl. G02F 1/1335; F21V 8/00

(52) U.S. Cl. CPC G02F 1/133555; G02B 6/0068

(57) ABSTRACT

A display apparatus is provided and includes a liquid crystal display portion; a partial transmission plate provided on a rear side of the liquid crystal display portion; a total reflection mirror that is provided opposite to the liquid crystal display portion across the partial transmission plate and faces the partial transmission plate with a space between the total reflection mirror and the partial transmission plate; a first light source that has a center axis of light emission directed to the partial transmission plate or the total reflection mirror and is configured to output light to a region between the partial transmission plate and the total reflection mirror; and an edge-type backlight including a second light source and a light guide configured to guide light output from the second light source. The edge-type backlight is provided at a position closer to the total reflection mirror than to the first light source.

### CROSS-REFERENCE TO RELATED APPLICATIONS

This application is a continuation application of International Application No. PCT/JP2024/008192, filed on March 5, 2024, and designated the U.S., which is based upon and claims priority to Japanese Patent Application No. 2023-114744, filed on July 12, 2023, the entire contents of which are incorporated herein by reference.

### BACKGROUND

### 1. Field of the Invention

The present disclosure relates to a display apparatus.

### 2. Description of the Related Art

There have been display apparatuses including a liquid crystal display portion, a backlight disposed on the rear surface of the liquid crystal display portion, and a reflection/transmission selection member provided between the liquid crystal display portion and the backlight (see, for example, Japanese Laid-Open Patent Application No. 1994-332386).

### SUMMARY

A display apparatus according to an embodiment of the present disclosure includes: a liquid crystal display portion; a partial transmission plate provided on a rear side of the liquid crystal display portion; a total reflection mirror that is provided opposite to the liquid crystal display portion across the partial transmission plate and faces the partial transmission plate with a space between the total reflection mirror and the partial transmission plate; a first light source that has a center axis of light emission directed to the partial transmission plate or the total reflection mirror and is configured to output light to a region between the partial transmission plate and the total reflection mirror; and an edge-type backlight including a second light source and a light guide configured to guide light output from the second light source. The edge-type backlight is provided closer to the total reflection mirror than to the first light source.

### BRIEF DESCRIPTION OF THE DRAWINGS

FIG. 1 is a diagram illustrating an example of a cross-sectional configuration of a display apparatus of a first embodiment.

FIG. 2A is a diagram illustrating an example of a configuration of a glass plate of a liquid crystal display portion of the display apparatus of the first embodiment.

FIG. 2B is a diagram illustrating the example of the configuration of the glass plate of the liquid crystal display portion of the display apparatus of the first embodiment.

FIG. 3 is a graph illustrating an example of characteristics of light transmittance of the liquid crystal display portion relative to a voltage applied to the liquid crystal display portion of the display apparatus of the first embodiment.

FIG. 4A is a cross-sectional diagram illustrating an example of a configuration of a display apparatus of a modified example of the first embodiment.

FIG. 4B is a cross-sectional diagram illustrating an example of a configuration of a display apparatus of a modified example of the first embodiment.

FIG. 4C is a cross-sectional diagram illustrating an example of a configuration of a display apparatus of a modified example of the first embodiment.

FIG. 4D is a cross-sectional diagram illustrating an example of a configuration of a display apparatus of a modified example of the first embodiment.

FIG. 4E is a cross-sectional diagram illustrating an example of a configuration of a display apparatus of a modified example of the first embodiment.

FIG. 4F is a cross-sectional diagram illustrating an example of a configuration of a display apparatus of a modified example of the first embodiment.

FIG. 4G is a cross-sectional diagram illustrating an example of a configuration of a display apparatus of a modified example of the first embodiment.

FIG. 5A is a diagram illustrating an example of experiment results of the display apparatus of the embodiment.

FIG. 5B is a diagram illustrating an example of experiment results of the display apparatus of the embodiment.

FIG. 6A is a diagram illustrating an example of a cross-sectional configuration of the display apparatus of the modified example of the embodiment.

FIG. 6B is a diagram illustrating an example of a cross-sectional configuration of the display apparatus of the modified example of the embodiment.

FIG. 7A is a diagram illustrating an example of a cross-sectional configuration of a display apparatus of a second embodiment.

FIG. 7B is a diagram illustrating an example of a positional relationship, in a plan view, between two types of light sources of the display apparatus of the second embodiment.

FIG. 8A is a cross-sectional diagram illustrating an example of a configuration of a display apparatus of a modified example of the second embodiment.

FIG. 8B is a cross-sectional diagram illustrating an example of a configuration of a display apparatus of a modified example of the second embodiment.

FIG. 8C is a cross-sectional diagram illustrating an example of a configuration of a display apparatus of a modified example of the second embodiment.

FIG. 8D is a cross-sectional diagram illustrating an example of a configuration of a display apparatus of a modified example of the second embodiment.

FIG. 8E is a cross-sectional diagram illustrating an example of a configuration of a display apparatus of a modified example of the second embodiment.

FIG. 9A is a diagram illustrating a measurement example of gradation control in the display apparatus of the modified example of the second embodiment.

FIG. 9B is a diagram illustrating the measurement example of the gradation control in the display apparatus of the modified example of the second embodiment.

### DETAILED DESCRIPTION OF THE INVENTION

An infinity mirror image is known, which is formed by repeatedly performing multiple reflections between a partial reflection mirror and a total reflection mirror, and repeatedly superimposing reflected imaginary images in a depth direction to appear to become smaller at a deeper position.

However, in conventional display apparatuses, light is incident substantially perpendicularly from a backlight toward a reflection/transmission selection member and a liquid crystal display portion, and thus an infinity mirror image due to the repeated multiple reflections cannot be obtained.

In view of this, it is an object to provide a display apparatus configured to display an infinity mirror image.

Hereinafter, embodiments to which a display apparatus of the present disclosure is applied will be described.

The following description will be made with an XYZ coordinate system being defined. An X axis is an example of a first axis, a Y axis is an example of a second axis, and a Z axis is an example of a third axis. A direction parallel to the X axis (X direction), a direction parallel to the Y axis (Y direction), and a direction parallel to the Z axis (Z direction) are orthogonal to each other. Also, in the following, a plan view refers to an XY view. Further, in the following, as an example, a +Z direction is referred to as upward, and a −Z direction is referred to as downward. However, this does not represent a universal upper-lower relationship. Also, in the following, the length, the thickness, and the like of each portion may be exaggerated for ease of understanding of a configuration.

### <First Embodiment>

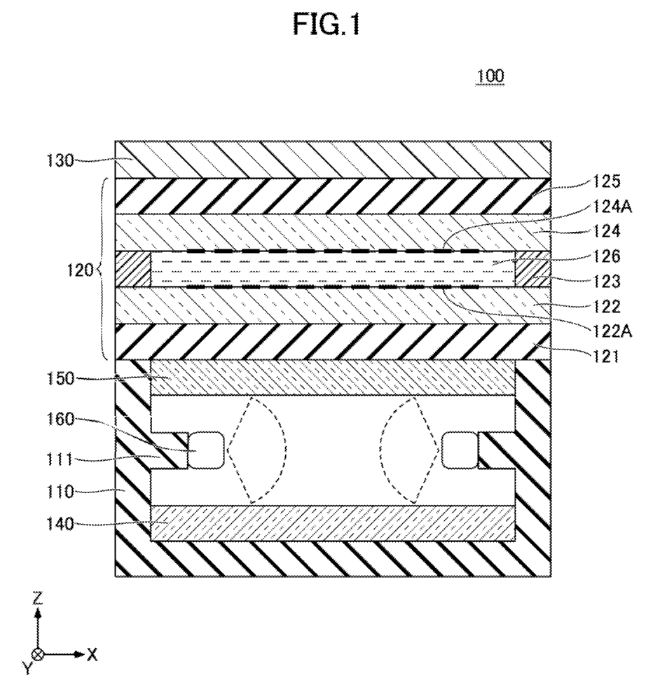

FIG. 1 is a diagram illustrating an example of a cross-sectional configuration of a display apparatus 100 of a first embodiment. The display apparatus 100 includes a casing 110, a liquid crystal display portion 120, an antireflection layer 130, a total reflection mirror 140, a partial reflection mirror 150, and light sources 160. The partial reflection mirror 150 is an example of a partial transmission plate.

The upper surface of the antireflection layer 130 is a display surface of the display apparatus 100. A transparent plate-like member, such as a cover glass or the like, may be provided between the antireflection layer 130 and a polarizing plate 125 of the liquid crystal display portion 120.

The display apparatus 100 is configured to display an image with a sense of depth. This is because light output from the light sources 160 repeats multiple reflections between the total reflection mirror 140 and the partial reflection mirror 150, and thus the reflected images are repeatedly superimposed at equal intervals to appear to become smaller at a deeper position.

In the following, such an image with a sense of depth due to multiple reflections will be referred to as an infinity mirror image. The infinity mirror image is easily visible when viewed from a direction slightly oblique to the front of the display apparatus 100 in the +Z direction.

### <Casing 110>

The casing 110 is a housing of the display apparatus 100. The casing 110 has, as an example, a box shape, and a rectangular shape in a plan view. The casing 110 includes an opening at an upper portion, and an inner space communicating with the opening and spreading downward. Such an inner space is an example of a region, and more specifically, an example of a three-dimensional region. The total reflection mirror 140 is disposed at the bottom of the inner space of the casing 110, and the partial reflection mirror 150 is provided in the upper opening. Also, the casing 110 includes projections 111 at center portions of four inner surfaces in the Z direction, and the projections 111 project toward the center of the inner space in a plan view. The light sources 160 are provided at the tips of the projections 111. The light sources 160 may be provided on the inner wall or the like of the casing 110 without providing the projections 111. Also, the inner space of the casing 110 may be sealed, for example, with a transparent resin. The portion of the inner space sealed with the transparent resin is a three-dimensional region inside the casing 110.

### <Liquid Crystal Display Portion 120>

The liquid crystal display portion 120 is provided over the casing 110. The liquid crystal display portion 120 includes a polarizing plate 121, a glass plate 122, a sealing seal 123, a glass plate 124, a polarizing plate 125, and a liquid crystal layer 126. The glass plate 124 is an example of a first glass plate, and the glass plate 122 is an example of a second glass plate. The liquid crystal display portion 120 is, as an example, a liquid crystal display portion driven by a passive driving method.

The polarizing plate 121 is provided over the lower surface of the glass plate 122, and the lower surface of the polarizing plate 121 is in contact with the upper surface of the partial reflection mirror 150. The polarizing plate 121 has a predetermined polarization direction corresponding to the arrangement of liquid crystals in the liquid crystal layer 126.

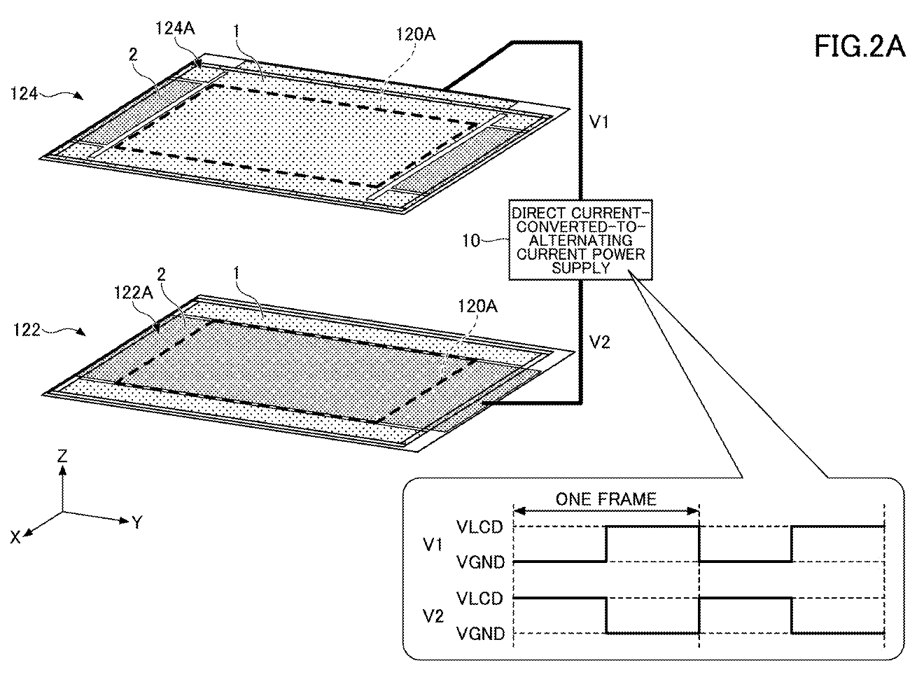

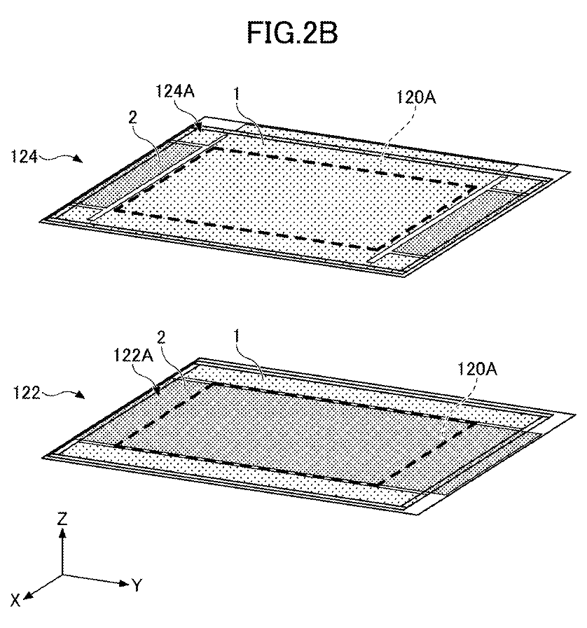

The glass plate 122 is a transparent glass plate provided on the lower-surface side of the liquid crystal layer 126. The lower-surface side of the liquid crystal layer 126 is an example of a second side (−Z direction side) opposite to a first side (+Z direction side), which is opposite to the partial reflection mirror 150 across the liquid crystal layer 126. Being “transparent” refers to transmitting light. Electrodes are provided over the upper surface of the glass plate 122. Broken lines indicate the position of a switchable region 120A defined by the electrodes over the upper surface of the glass plate 122 and the electrodes over the lower surface of the glass plate 124. The electrodes provided over the upper surface of the glass plate 122 can be formed by a transparent conductive film, e.g., an ITO (Indium Tin Oxide) film. Details of the electrodes provided over the upper surface of the glass plate 122 will be described below with reference to FIGS. 2A and 2B.

The sealing seal 123 is a frame-like member provided between the glass plates 122 and 124. Here, since the display apparatus 100 is rectangular in a plan view as an example, the sealing seal 123 has a rectangular ring shape in a plan view. The sealing seal 123 is formed of an insulator, e.g., a resin. The sealing seal 123 is bonded between the glass plates 122 and 124, and seals the liquid crystal layer 126 along with the glass plates 122 and 124.

The glass plate 124 is a transparent glass plate provided on the upper side of the liquid crystal layer 126. The upper-surface side of the liquid crystal layer 126 is an example of the first side (+Z direction side) opposite to the partial reflection mirror 150 across the liquid crystal layer 126. The meaning of “transparent” is the same as in the glass plate 122. Electrodes are provided over the lower surface of the glass plate 124. Broken lines indicate the position of the switchable region 120A defined by the electrodes over the lower surface of the glass plate 124 and the electrodes over the upper surface of the glass plate 122. The electrodes provided over the lower surface of the glass plate 124 can be formed by a transparent conductive film, e.g., an ITO film. Details of the electrodes provided over the lower surface of the glass plate 124 will be described below with reference to FIGS. 2A and 2B.

The polarizing plate 125 is provided over the glass plate 124. The polarizing plate 125 has a predetermined polarization direction.

The liquid crystal layer 126 is provided in a space sealed by the glass plates 122 and 124 and the sealing seal 123. A voltage applied to the liquid crystal layer 126 from the electrode over the upper surface of the glass plate 122 and the electrode over the lower surface of the glass plate 124 changes the orientation directions of the liquid crystal molecules to change the light transmittance as viewed from the upper-surface side.

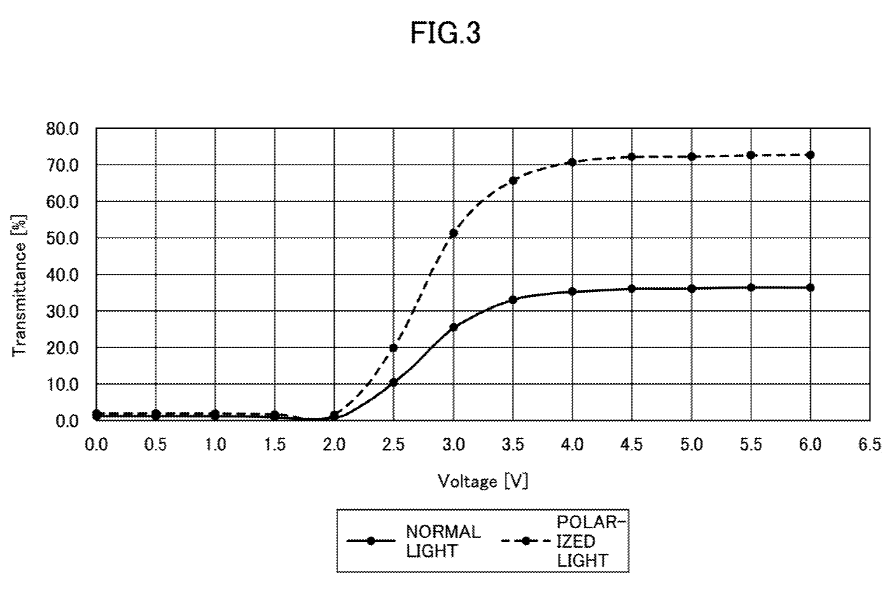

The liquid crystal layer 126 is configured to be transparent to transmit light by an electric field being applied, and to be opaque not to transmit light without an electric field being applied. Control of the transmittance of the liquid crystal layer 126 will be described below with reference to FIG. 3.

### <Antireflection Layer 130>

The antireflection layer 130 is provided over the uppermost surface of the display apparatus 100. As an example, the antireflection layer 130 is formed by an AR (Anti Reflection) film. The antireflection layer 130 may be provided over the surface of a transparent plate-like member, such as a cover glass or the like. Note that such a transparent plate-like member, such as a cover glass or the like, is an example of a protective plate.

### <Total Reflection Mirror 140>

The total reflection mirror 140 is provided at the bottom of the inner space of the casing 110, and the upper surface of the total reflection mirror 140 is a reflective surface configured to totally reflect light. As an example, the total reflection mirror 140 can be produced by polishing the upper surface of a plate-like member, followed by deposition of aluminum. Note that the total reflection mirror 140 is not limited to such a configuration, and may be a mirror with any configuration as long as the mirror has an upper surface that is a reflective surface configured to totally reflect light.

### <Partial Reflection Mirror 150>

The partial reflection mirror 150 is provided in the upper opening of the casing 110. As an example, the light transmittance of the partial reflection mirror 150 may be set to an appropriate value from about 20% to about 80%, and more preferably set to an appropriate value from about 30% to about 70%. Here, as an example, the light transmittance of the partial reflection mirror 150 is assumed to be 50%.

The partial reflection mirror 150 transmits, from the upper surface toward the lower surface, a portion of light transmitted from the upper side toward the lower side of the liquid crystal display portion 120, and reflects the remaining light toward the liquid crystal display portion 120 at the upper surface. Also, the partial reflection mirror 150 transmits light coming from below, from the lower surface toward the upper surface, and reflects the remaining light downward at the lower surface.

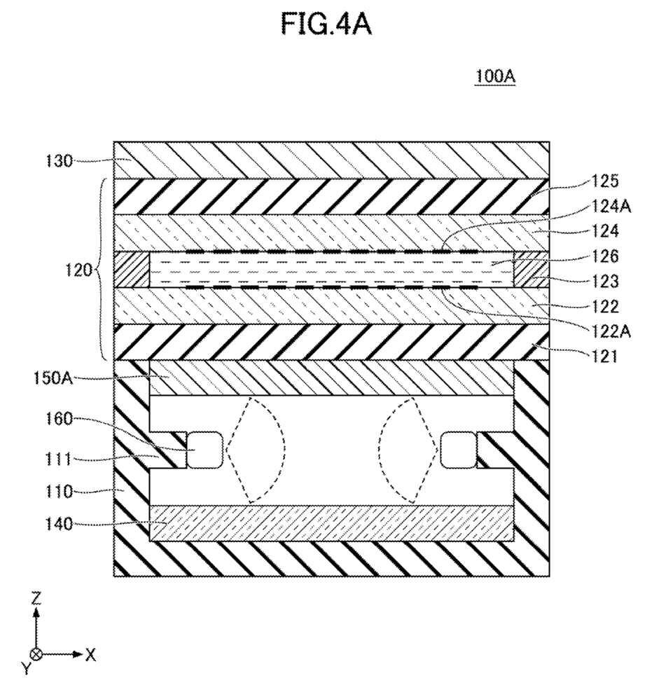

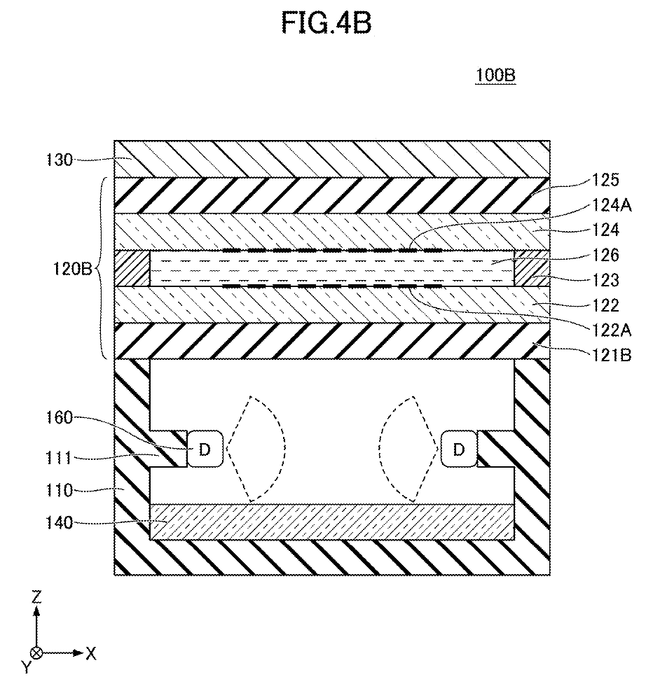

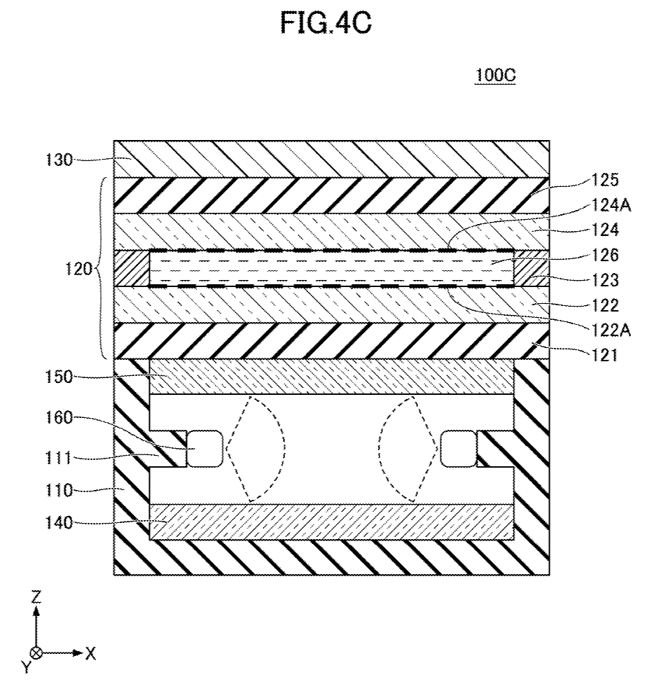

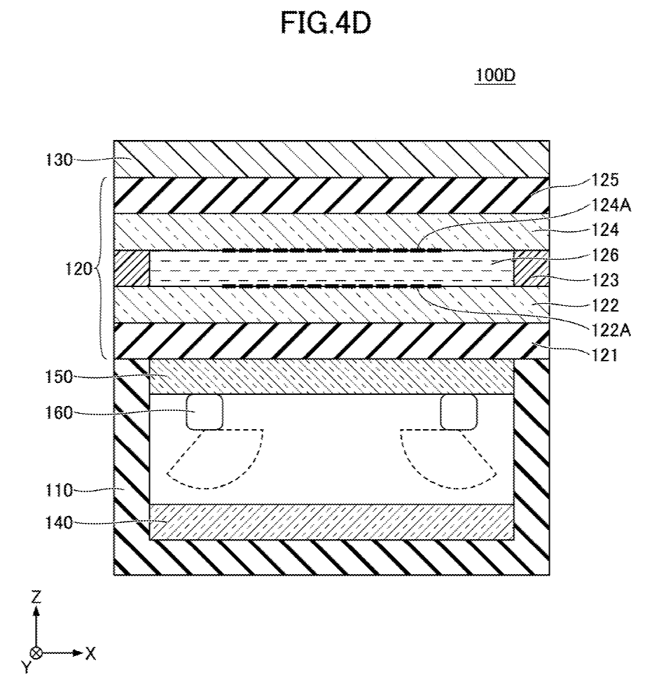

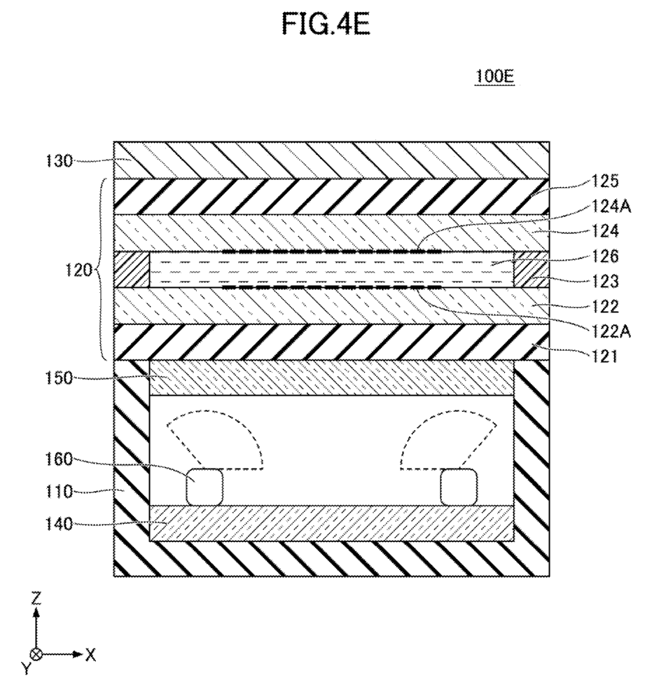

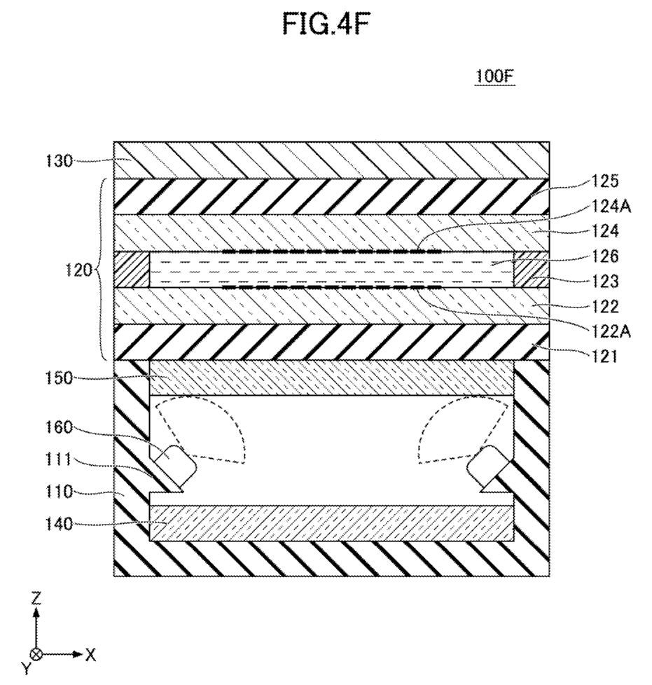

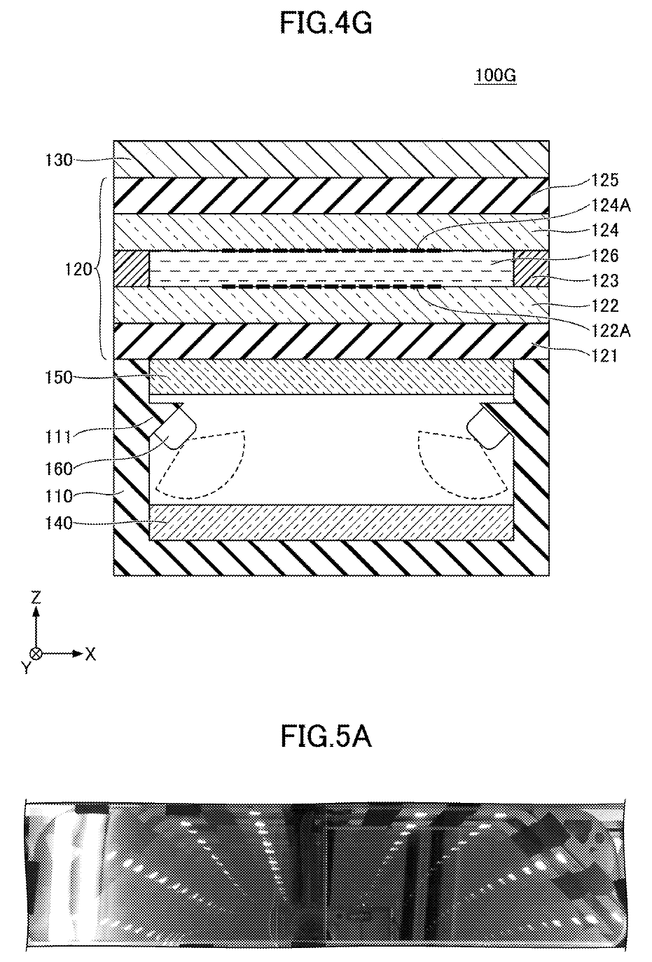

Here, a configuration in which the partial reflection mirror 150 is used as an example of a partial transmission plate will be described. However, the partial transmission plate may be as desired, as long as the partial transmission plate is a plate-like member configured to transmit a portion of incident light. Also, since non-transmitting light is reflected at the surface of the partial transmission plate of such a plate-like member, the partial transmission plate transmits a portion of the incident light and reflects the remaining light. The reflectance of the partial transmission plate may be a very low value, e.g., 10% or lower. The partial transmission plate other than the partial reflection mirror 150 will be described below with reference to FIG. 4A.

### <Light Source 160>

The light sources 160 are provided at the tips of the projections 111 of the casing 110. The light sources 160 are, as an example, LEDs (Light Emitting Diodes), and may be any light emitters other than LEDs. As an example, the projections 111 extend from the four inner surfaces of the casing 110 toward the center of the inner space of the casing 110 in a plan view, and the light sources 160 are arranged in a rectangular ring shape at equal intervals in a plan view. The light sources 160 are disposed outside the switchable region of the liquid crystal display portion 120 in a plan view. The light sources 160 output light to a space (region) between the partial reflection mirror 150 and the total reflection mirror 140.

Terminals of the light sources 160 are connected to an external device of the display apparatus 100 via interconnects or the like (not shown), and control of lighting of each light source 160 is performed by the external device, as an example.

The center axes of light emission of the light sources 160 are inclined relative to a straight line perpendicular to the lower surface of the partial reflection mirror 150 and the upper surface of the total reflection mirror 140 (a straight line parallel to the Z axis). The center axes of light emission of the light sources 160 are the center axis of a three-dimensional radiation range of the light output by the light sources 160. This is because, by inclining the center axes of light emission of the light sources 160 relative to the straight line perpendicular to the lower surface of the partial reflection mirror 150 and the upper surface of the total reflection mirror 140 (the straight line parallel to the Z axis), light is obliquely incident on the total reflection mirror 140 and the partial reflection mirror 150, thereby increasing the number of multiple reflections and obtaining an infinity mirror image with a greater depth.

As an example, the center axes of light emission of the light sources 160 have an angle of about 70 degrees as an absolute value relative to the straight line perpendicular to the lower surface of the partial reflection mirror 150 and the upper surface of the total reflection mirror 140 (the straight line parallel to the Z-axis). In other words, as an example, the center axes of light emission of the light sources 160 have an angle of about 20 degrees upward or downward relative to the horizontal direction.

### <Configurations of Glass Plates 122 and 124>

FIGS. 2A and 2B are diagrams illustrating configurations of the glass plates 122 and 124 of the liquid crystal display portion 120. FIGS. 2A and 2B illustrate the electrode 122A included in the glass plate 122 and the electrode 124A included in the glass plate 124 such that the electrode 122A and the electrode 124A are transmissive. The electrode 122A is provided substantially all over the upper surface (+Z direction-side surface) of the glass plate 122, and the electrode 124A is provided substantially all over the lower surface (−Z direction-side surface) of the glass plate 124. The electrodes 122A and 124A can be formed by a transparent conductive film, e.g., an ITO film.

FIG. 2A illustrates a state in which a control voltage is applied to the electrodes 122A and 124A of the liquid crystal display portion 120, and FIG. 2B illustrates a state in which a control voltage is not applied to the electrodes 122A and 124A of the liquid crystal display portion 120. For this reason, FIG. 2A illustrates a direct current-converted-to-alternating current power supply 10.

The electrodes 122A and 124A are disposed to face each other. The electrode 122A includes two electrodes 1 and one electrode 2. The electrode 124A includes one electrode 1 and two electrodes 2. The electrodes 1 of the electrode 122A and the electrode 1 of the electrode 124A are an example of a pair of first electrodes. The electrode 2 of the electrode 122A and the electrodes 2 of the electrode 124A are an example of a pair of second electrodes.

The two electrodes 1 of the electrode 122A and the one electrode 1 of the electrode 124A are connected via interconnects or the like (not shown), and are configured to have the same potential. The one electrode 2 of the electrode 122A and the two electrodes 2 of the electrode 124A are connected via interconnects or the like (not shown), and are configured to have the same potential. Also, direct current-converted-to-alternating current voltages V1 and V2 having opposite phases and equal amplitudes are applied from the direct current-converted-to-alternating current power supply 10 to the electrode 1 of the electrode 124A and the electrode 2 of the electrode 122A. As illustrated in the lower portion of FIG. 2A, the direct current-converted-to-alternating current voltages V1 and V2 have a period for applying VLCD (> VGND) and a period for applying VGND in one frame. VGND is a ground voltage.

Therefore, in a state in which the direct current-converted-to-alternating current power supply 10 outputs the direct current-converted-to-alternating current voltage, a potential difference occurs between the electrodes 1 and 2. Also, in the state in which the direct current-converted-to-alternating current power supply 10 outputs the direct current-converted-to-alternating current voltage, the two electrodes 1 of the electrode 122A and the one electrode 1 of the electrode 124A have the same potential, and the one electrode 2 of the electrode 122A and the two electrodes 2 of the electrode 124A have the same potential.

FIGS. 2A and 2B illustrate the switchable region 120A of the liquid crystal display portion 120 configured by the electrodes 122A and 124A.

The switchable region 120A is a region of the display surface of the liquid crystal display portion 120, in which an image to be displayed can be switched. The switchable region 120A is located at the center, in a plan view, in a display surface of the liquid crystal display portion 120 excluding the rectangular ring portion along the outer periphery of the display surface. The width of the rectangular ring portion along the outer periphery of the display surface (the width between the outer periphery of the display surface and the switchable region 120A) is, as an example, about 1 mm to about 20 mm. The width of the rectangular ring portion along the outer periphery of the display surface may be smaller than 1 mm or may be larger than 20 mm.

The electrode 2 of the electrode 122A and the electrode 1 of the electrode 124A are provided in the switchable region 120A.

### <Electrode 122A>

The electrode 122A is configured such that the electrode 1, the electrode 2, and the electrode 1 are arranged in this order from the −X direction side to the +X direction side.

The electrode 1 on the −X direction side of the electrode 122A is provided on the −X direction side of the switchable region 120A in the X direction, and extends from a −Y direction-side end to a +Y direction-side end of the electrode 122A in the Y direction. The electrode 1 on the +X direction side of the electrode 122A is provided on the +X direction side of the switchable region 120A in the X direction, and extends from the −Y direction-side end to the +Y direction-side end of the electrode 122A.

The electrode 2 of the electrode 122A extends in a section between an −X direction-side end to an +X direction-side end of the switchable region 120A in the X direction, and extends from the −Y direction-side end to the +Y direction-side end of the electrode 122A in the Y direction. The electrode 2 of the electrode 122A, configured to apply a voltage to the switchable region 120A, extends to the ends in the Y direction (second direction), which crosses the X direction (first direction) of the glass plate 122 in a plan view.

As an example, the electrode 2 of the electrode 122A is connected to the direct current-converted-to-alternating current power supply 10 via a terminal or the like connected to the +Y direction-side end of the glass plate 122. When the electrode 2 of the electrode 122A extends to the end of the glass plate 122, the electrode 2 of the electrode 122A is easily connected to the direct current-converted-to-alternating current power supply 10 outside the liquid crystal display portion 120. Note that, as an example, the electrode 2 of the electrode 122A, configured to apply a voltage to the switchable region 120A, may be connected to the direct current-converted-to-alternating current power supply 10 via a terminal or the like connected to the −Y direction-side end of the glass plate 122.

Also, as an example, the two electrodes 1 of the electrode 122A are connected to the electrode 1 of the electrode 124A with a conductor being sandwiched between the two electrodes 1 of the electrode 122A and the electrode 1 of the electrode 124A. Further, as an example, the two electrodes 1 of the electrode 122A may be connected to the electrode 1 of the electrode 124A via interconnects or the like connected to the electrode 1 of the electrode 124A. Also, as an example, the two electrodes 1 of the electrode 122A may be connected to the direct current-converted-to-alternating current power supply 10 via terminals or the like connected to the ends in the −X direction and the +X direction. In this manner, the two electrodes 1 of the electrode 122A and the electrode 1 of the electrode 124A are maintained to have the same potential.

### <Electrode 124A>

The electrode 124A is formed by the electrode 1 having an H shape and the two electrodes 2 that are rectangular. The two electrodes 2 are respectively disposed in two portions remaining by excluding the H-shaped electrode 1 from the electrode 124A, which has a rectangular shape as a whole.

The electrode 2 on the −Y direction side of the electrode 124A extends in a section between the −X direction-side end and the +X direction-side end of the switchable region 120A in the X direction, and is located on the −Y direction side of the switchable region 120A in the Y direction. The electrode 2 on the +Y direction side of the electrode 124A extends in a section between the −X direction-side end and the +X direction-side end of the switchable region 120A in the X direction, and is located on the +Y direction side of the switchable region 120A in the Y direction.

The electrode 1 of the electrode 124A is disposed in an H-shaped portion remaining by excluding the two electrodes 1 as described above from the electrode 124A, which has a rectangular shape as a whole, in a plan view. The electrode 1 of the electrode 124A, configured to apply a voltage to the switchable region 120A, extends to an end of the glass plate 124 in the X direction (first direction). As an example, the electrode 1 of the electrode 124A is connected to the direct current-converted-to-alternating current power supply 10 via a terminal or the like connected to the −X direction-side end of the glass plate 124.

When the electrode 1 of the electrode 124A extends to the end of the glass plate 124, the electrode 1 of the electrode 124A is easily connected to the direct current-converted-to-alternating current power supply 10 outside the liquid crystal display portion 120. Note that, as an example, the electrode 1 of the electrode 124A, configured to apply a voltage to the switchable region 120A, may be connected to the direct current-converted-to-alternating current power supply 10 via a terminal or the like connected to the +X direction-side end of the glass plate 124.

As an example, the two electrodes 2 of the electrode 124A are connected to the electrode 2 of the electrode 122A with a conductor being sandwiched between the two electrodes 2 of the electrode 124A and the electrode 2 of the glass plate 122. Further, as an example, the two electrodes 2 of the electrode 124A may be connected to the electrode 2 of the electrode 122A via interconnects or the like connected to the electrode 2 of the electrode 122A. Also, as an example, the two electrodes 2 of the electrode 124A may be connected to the direct current-converted-to-alternating current power supply 10 via terminals or the like connected to the ends in the −Y direction and the +Y direction. In this manner, the two electrodes 2 of the electrode 124A and the electrode 2 of the electrode 122A are maintained to have the same potential.

In the electrodes 122A and 124A, the electrode 2 of the electrode 122A and the electrodes 2 of the electrode 124A face each other in a portion outside the switchable region 120A and in a section between the −Y direction-side end and the +Y direction-side end of the switchable region 120A in the Y direction. The description “electrodes facing each other” has the same meaning that the electrodes overlap with each other with a space being between the electrodes.

As illustrated in FIG. 2A, when direct current-converted-to-alternating current voltages are applied between the electrodes 1 and 2 from the direct current-converted-to-alternating current power supply 10, a potential difference occurs between the electrodes 1 and 2, thereby generating an electric field in a portion of the liquid crystal layer 126 in the switchable region 120A. Also, even if direct current-converted-to-alternating current voltages are applied between the electrodes 1 and 2 from the direct current-converted-to-alternating current power supply 10, resulting in generation of a potential difference between the electrodes 1 and 2, no potential difference occurs in a portion of the liquid crystal layer 126 outside the switchable region 120A, and thus no electric field is generated.

By an electric field being applied to the liquid crystal layer 126, the liquid crystal layer 126 becomes in a state in which the liquid crystal layer 126 can transmit light. Without an electric field being applied to the liquid crystal layer 126, the liquid crystal layer 126 becomes in a state in which the liquid crystal layer 126 does not transmit light. Therefore, applying direct current-converted-to-alternating current voltages between the electrodes 1 and 2 enables the switchable region 120A to transmit light. Also, since the electrodes 1 face each other and the electrodes 2 face each other in the portion outside the switchable region 120A in the liquid crystal display portion 120, even if direct current-converted-to-alternating current voltages are applied between the electrodes 1 and 2, the liquid crystal layer 126 is maintained to be in a state in which the liquid crystal layer 126 does not transmit light.

Without direct current-converted-to-alternating current voltages being applied between the electrodes 1 and 2, no potential difference occurs between the electrodes 1 and 2 in the switchable region 120A. Thus, the switchable region 120A becomes in a state in which the switchable region 120A does not transmit light. Also, since the facing electrodes 1 have the same potential and the facing electrodes 2 have the same potential, the liquid crystal layer 126 is maintained to be in a state in which the liquid crystal layer 126 does not transmit light in the portion outside the switchable region 120A in the liquid crystal display portion 120.

In this manner, by switching between the state of applying the direct current-converted-to-alternating current voltages between the electrodes 1 and 2 and the state of not applying the direct current-converted-to-alternating current voltages between the electrodes 1 and 2, it is possible to switch the transmission state of the switchable region 120A of the liquid crystal display portion 120, like a shutter of an imaging apparatus. Also, in the portion outside the switchable region 120A in the liquid crystal display portion 120, the liquid crystal layer 126 is always maintained to be in a state in which the liquid crystal layer 126 does not transmit light regardless of whether or not the direct current-converted-to-alternating current voltages are applied between the electrodes 1 and 2.

Since the display apparatus 100 can display an infinity mirror image, by switching the transmission state of the switchable region 120A of the liquid crystal display portion 120, it is possible to switch between a state of displaying the infinity mirror image and a state of not displaying the infinity mirror image.

Since the gap between the glass plates 122 and 124 is sealed by the sealing seal 123 along the outer periphery (four sides) of the glass plates 122 and 124, the electrodes 122A and 124A may be offset inward of the outer periphery (four sides) of the glass plates 122 and 124 in a plan view to avoid overlapping with the sealing seal 123. Portions of the electrodes 122A and 124A to be connected to terminals or the like only need to extend up to the outer periphery of the glass plates 122 and 124 such that the electrodes 122A and 124A are connected to the direct current-converted-to-alternating current power supply 10 via the terminals or the like. In this case, portions of the glass plates 122 and 124, over which the electrodes 122A and 124A to be connected to the terminals or the like are formed, may project outward from the sealing seal 123 in a plan view.

### Light Transmittance in Liquid Crystal Display Portion 120

FIG. 3 is a graph illustrating an example of characteristics of light transmittance of the liquid crystal display portion 120 relative to a voltage applied to the liquid crystal display portion 120. The voltage applied to the liquid crystal display portion 120 is an direct current-converted-to-alternating current voltage having a phase opposite to that applied between the electrodes 1 and 2. The voltage on the horizontal axis in FIG. 3 represents an amplitude of the direct current-converted-to-alternating current voltage of the opposite phase.

Here, the characteristics of the light transmittance without polarizing covers being attached to the light sources 160 (without the polarizing covers) are shown by a solid line, and the characteristics of the light transmittance with polarizing covers being attached to the light sources 160 (with the polarizing covers) are shown by a broken line. The polarization direction of the polarizing covers attached to the light sources 160 coincides with the polarization direction of the polarizing plate 121 located below the liquid crystal layer 126.

When the voltage is from 0.0 V to about 2.0 V, the transmittances in both the light sources 160 with the polarizing covers and the light sources 160 without the polarizing covers were very low values, i.e., about 1% to about 2%. This state is a state in which no light is transmitted. When the voltage exceeded 2.0 V, the transmittances in both the light sources 160 with the polarizing covers and the light sources 160 without the polarizing covers began to rapidly increase. The increase rate of the transmittance in the light sources 160 with the polarizing covers is greater than the increase rate of the transmittance in the light sources 160 without the polarizing covers.

When the voltage exceeds about 4.0 V, the transmittances in both the light sources 160 with the polarizing covers and the light sources 160 without the polarizing covers became substantially constant. When the voltage was increased to 6.0 V, the maximum transmittance in the light sources 160 with the polarizing covers was about 73%, and the maximum transmittance in the light sources 160 without the polarizing covers was about 37%. The maximum transmittance in the light sources 160 with the polarizing covers was about two times greater than the maximum transmittance in the light sources 160 without the polarizing covers.

In this manner, it was confirmed that, by controlling the voltage applied to the electrodes 1 and 2, the transmittance of the liquid crystal display portion 120 could be switched between a very low value, i.e., about 1% to about 2%, and a value indicating the ability to transmit light, i.e., about 37% or about 73%.

For example, for immediately switching the switchable region 120A from a non-transmission state to a transmission state, the voltage applied to the electrodes 1 and 2 can be immediately increased from 0.0 V to 6.0 V. Also, for example, for gradually switching the switchable region 120A from a non-transmission state to a transmission state, the voltage applied to the electrodes 1 and 2 can be gradually increased from 2.0 V to 4.0 V.

### Display Apparatuses 100A to 100G of Modified Examples of First Embodiment

FIGS. 4A to 4G are cross-sectional diagrams illustrating examples of configurations of display apparatuses 100A to 100G of modified examples of the first embodiment. FIGS. 4A to 4G illustrate cross-sectional configurations in an XZ plane corresponding to the display apparatus 100 illustrated in FIG. 1. The same components as the components of the display apparatus 100 illustrated in FIG. 1 are denoted by the same reference signs, and description thereof is omitted.

### <Display Apparatus 100A>

A display apparatus 100A illustrated in FIG. 4A includes a hard coat 150A instead of the partial reflection mirror 150 of the display apparatus 100 illustrated in FIG. 1. The hard coat 150A is an example of the partial transmission plate.

The hard coat 150A is, as an example, a semi-transparent hard resin layer. The reflectance of the hard coat 150A is lower than the transmittance of the hard coat 150A. The reflectance of the hard coat 150A may be, for example, about 10% or lower than 10%. That is, the transmittance of the hard coat 150A may be about 90% or higher than 90%.

The hard coat 150A transmits, from the upper surface toward the lower surface, a portion of light transmitted from the upper side toward the lower side of the liquid crystal display portion 120, and reflects the remaining light toward the liquid crystal display portion 120 at the upper surface. Also, the hard coat 150A transmits light coming from below, from the lower surface toward the upper surface, and reflects the remaining light downward at the lower surface.

Therefore, in the display apparatus 100A including the hard coat 150A, an infinity mirror image is displayed at a low density by an amount commensurate with the low reflectance compared to that in use of the partial reflection mirror 150. However, the display apparatus 100A including the hard coat 150A can display the infinity mirror image, similarly to the display apparatus 100 including the partial reflection mirror 150. Therefore, even if the hard coat 150A is used instead of the partial reflection mirror 150, it is possible to provide the display apparatus 100A configured to switch the infinity mirror image not to be displayed. Also, since the hard coat 150A is less expensive than the partial reflection mirror 150, the display apparatus 100A producible at a lower cost can be provided. The light sources 160 may be provided on the inner wall or the like of the casing 110 without providing the projections 111.

### <Display Apparatus 100B>

A display apparatus 100B illustrated in FIG. 4B includes a reflection-type polarizing plate 121B instead of the polarizing plate 121 and the partial reflection mirror 150 of the display apparatus 100 illustrated in FIG. 1. The reflection-type polarizing plate 121B is included in a liquid crystal display portion 120B. The liquid crystal display portion 120B includes the reflection-type polarizing plate 121B instead of the polarizing plate 121 illustrated in FIG. 1.

The reflection-type polarizing plate 121B functions as a polarizing plate similarly to the polarizing plate 121, and has the same function as that of the partial reflection mirror 150. The reflection-type polarizing plate 121B is an example of the partial transmission plate. As an example, the light transmittance of the reflection-type polarizing plate 121B may be set to an appropriate value from about 20% to about 80%, and more preferably may be set to an appropriate value from about 30% to about 70%. Here, as an example, the light transmittance of the reflection-type polarizing plate 121B is assumed to be 50%.

The reflection-type polarizing plate 121B transmits and polarizes, from the upper surface toward the lower surface, a portion of light transmitted from the upper side toward the lower side of the liquid crystal display portion 120, and reflects the remaining light toward the liquid crystal display portion 120 at the upper surface. Also, the reflection-type polarizing plate 121B transmits and polarizes light coming from below, from the lower surface toward the upper surface, and reflects the remaining light downward at the lower surface.

Therefore, the display apparatus 100B including the reflection-type polarizing plate 121B can operate similarly to the display apparatus 100 including the polarizing plate 121 and the partial reflection mirror 150. Therefore, it is possible to provide the display apparatus 100B configured to switch the infinity mirror image not to be displayed. The light sources 160 may be provided on the inner wall or the like of the casing 110 without providing the projections 111.

### <Display Apparatus 100C>

A display apparatus 100C illustrated in FIG. 4C has a configuration the same as the configuration of the display apparatus 100 illustrated in FIG. 1 except that the switchable region 120A is enlarged in a plan view. In the cross section of FIG. 4C, the switchable region 120A is located over the entirety of a portion of the glass plates 122 and 124 with which the sealing seal 123 does not overlap.

For achieving the enlarged switchable region 120A, as an example, the electrode 122A illustrated in FIGS. 2A and 2B can be entirely formed by the electrode 1, and the electrode 124A illustrated in FIGS. 2A and 2B can be entirely formed by the electrode 2. In this case, there is no portion in which the electrodes 1 or the electrodes 2 face each other outside the switchable region 120A illustrated in FIGS. 2A and 2B.

In the display apparatus 100C, by switching the enlarged switchable region 120A between a transmission state and a non-transmission state, it is possible to switch between a state of displaying the infinity mirror image and a state of not displaying the infinity mirror image. Therefore, it is possible to provide the display apparatus 100C configured to switch the infinity mirror image not to be displayed. The light sources 160 may be provided on the inner wall or the like of the casing 110 without providing the projections 111.

Also, the enlarged switchable region 120A described here may be applied to the display apparatus 100A illustrated in FIG. 4A and the display apparatus 100B illustrated in FIG. 4B.

### <Display Apparatus 100D>

A display apparatus 100D illustrated in FIG. 4D has a configuration the same as the configuration of the display apparatus 100 illustrated in FIG. 1 except that the light sources 160 are attached to the lower surface of the partial reflection mirror 150. In this configuration, the projections 111 are not necessary. The light sources 160 are disposed, in a plan view, along the switchable region 120A and outside the switchable region 120A. Also, the light sources 160 are disposed to face obliquely downward toward the center of the total reflection mirror 140. That is, the center axes of light emission of the light sources 160 are inclined relative to the straight line perpendicular to the lower surface of the partial reflection mirror 150 and the upper surface of the total reflection mirror 140 (the straight line parallel to the Z axis).

In the display apparatus 100D including the light sources 160 disposed in this manner, a portion of light output from the light sources 160 and reflected by the total reflection mirror 140 is transmitted through the partial reflection mirror 150, and the remaining light is reflected again by the total reflection mirror 140. By repeating this, reflected imaginary images obtained between the total reflection mirror 140 and the partial reflection mirror 150 are repeatedly superimposed at equal intervals in the depth direction while gradually becoming smaller. Thus, an infinity mirror image is obtained as in the display apparatus 100 illustrated in FIG. 1.

### <Display Apparatus 100E>

A display apparatus 100E illustrated in FIG. 4E has a configuration the same as the configuration of the display apparatus 100 illustrated in FIG. 1 except that the light sources 160 are attached to the upper surface of the total reflection mirror 140. In this configuration, the projections 111 are not necessary. The light sources 160 are disposed, in a plan view, along the switchable region 120A and outside the switchable region 120A. Also, the light sources 160 are disposed to face obliquely upward toward the center of the partial reflection mirror 150. That is, the center axes of light emission of the light sources 160 are inclined relative to the straight line perpendicular to the lower surface of the partial reflection mirror 150 and the upper surface of the total reflection mirror 140 (the straight line parallel to the Z axis).

In the display apparatus 100E including the light sources 160 disposed in this manner, a portion of light output from the light sources 160 is transmitted through the partial reflection mirror 150, the remaining light is reflected by the total reflection mirror 140, and is incident on the partial reflection mirror 150 again. By repeating this, reflected imaginary images obtained between the total reflection mirror 140 and the partial reflection mirror 150 are repeatedly superimposed at equal intervals in the depth direction while gradually becoming smaller. Thus, an infinity mirror image is obtained as in the display apparatus 100 illustrated in FIG. 1.

### <Display Apparatus 100F>

A display apparatus 100F illustrated in FIG. 4F has a configuration the same as the configuration of the display apparatus 100 illustrated in FIG. 1 except that the light sources 160 are attached to the projections 111 to face obliquely upward. The projections 111 of the display apparatus 100F are inclined such that the light sources 160 face obliquely upward. The light sources 160 are disposed to face obliquely upward toward the center of the partial reflection mirror 150. That is, the center axes of light emission of the light sources 160 are inclined relative to the straight line perpendicular to the lower surface of the partial reflection mirror 150 and the upper surface of the total reflection mirror 140 (the straight line parallel to the Z axis).

In the display apparatus 100F including the light sources 160 disposed in this manner, a portion of light output from the light sources 160 is transmitted through the partial reflection mirror 150, the remaining light is reflected by the total reflection mirror 140, and is incident on the partial reflection mirror 150 again. By repeating this, reflected imaginary images obtained between the total reflection mirror 140 and the partial reflection mirror 150 are repeatedly superimposed at equal intervals in the depth direction while gradually becoming smaller. Thus, an infinity mirror image is obtained as in the display apparatus 100 illustrated in FIG. 1. The light sources 160 may be provided on the inner wall or the like of the casing 110 without providing the projections 111.

### <Display Apparatus 100G>

A display apparatus 100G illustrated in FIG. 4G has a configuration the same as the configuration of the display apparatus 100 illustrated in FIG. 1 except that the light sources 160 are attached to the projections 111 to face obliquely downward. The projections 111 of the display apparatus 100G are inclined such that the light sources 160 face obliquely downward. The light sources 160 are disposed to face obliquely downward toward the center of the total reflection mirror 140. That is, the center axes of light emission of the light sources 160 are inclined relative to the straight line perpendicular to the lower surface of the partial reflection mirror 150 and the upper surface of the total reflection mirror 140 (the straight line parallel to the Z axis).

In the display apparatus 100G including the light sources 160 disposed in this manner, a portion of light output from the light sources 160 and reflected by the total reflection mirror 140 is transmitted through the partial reflection mirror 150, and the remaining light is reflected again by the total reflection mirror 140. By repeating this, reflected imaginary images obtained between the total reflection mirror 140 and the partial reflection mirror 150 are repeatedly superimposed at equal intervals in the depth direction while gradually becoming smaller. Thus, an infinity mirror image is obtained as in the display apparatus 100 illustrated in FIG. 1. The light sources 160 may be provided on the inner wall or the like of the casing 110 without providing the projections 111.

### <Experiment Results of Infinite Mirror Image>

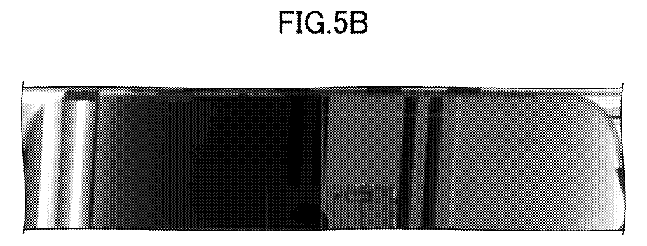

FIGS. 5A and 5B are diagrams illustrating an example of experiment results of the display apparatus of the embodiment. FIG. 5A illustrates a state in which the switchable region 120A of the liquid crystal display portion 120 is switched to be in a transmission state, and the antireflection layer 130 is viewed. FIG. 5B illustrates a state in which the switchable region 120A of the liquid crystal display portion 120 is switched to be in a non-transmission state, and the antireflection layer 130 is viewed.

A display apparatus for experiments has the structure of the display apparatus 100 (see FIG. 1) on the left half and the structure of the display apparatus 100B (see FIG. 4B) on the right half. That is, the display apparatus for experiments includes the partial reflection mirror 150 on the left half and includes the reflection-type polarizing plate 121B on the right half.

In FIG. 5A, the light sources 160 and other internal structures are visible along the left and right edges and the upper edge. The other internal structures on the left half are, for example, the inner surface of the casing 110 between the total reflection mirror 140 and the partial reflection mirror 150. The other internal structures on the right half are, for example, the inner surface of the casing 110 between the total reflection mirror 140 and the reflection-type polarizing plate 121B. Black objects existing along the left and right edges and the upper edge are pieces of black resin tape for fixing.

As illustrated in FIG. 5A, an infinity mirror image was obtained by repeatedly superposing the reflected imaginary images of the light sources 160 and the reflected imaginary images of the other internal structures at equal intervals in the depth direction while gradually becoming smaller.

As illustrated in FIG. 5B, in the state in which the switchable region 120A is switched to be in the non-transmission state, nothing appears on the left half to be in black, and the front image of the antireflection layer 130 appears on the right half like a mirror.

As described above, when the switchable region 120A is switched to be in the transmission state, the infinity mirror image is displayed as illustrated in FIG. 5A. Also, when the switchable region 120A is switched to be in the non-transmission state, the infinity mirror image can be non-displayed as illustrated in FIG. 5B.

Also, as illustrated in FIG. 5B, when the partial reflection mirror 150 is used, a black display without anything appearing in the antireflection layer 130 can be obtained in the non-transmission state, and when the reflection-type polarizing plate 121B is used, a display with the antireflection layer 130 appearing can be obtained in the non-transmission state.

### <Effects>

The display apparatus 100 includes the liquid crystal display portion 120, the partial transmission plate provided on the rear side of the liquid crystal display portion 120, the total reflection mirror 140 that is provided opposite to the liquid crystal display portion 120 across the partial transmission plate and faces the partial transmission plate with the space between the total reflection mirror 140 and the partial transmission plate, and the light sources 160 (first light source) that have the center axes of light emission directed to the partial transmission plate or the total reflection mirror 140 and are configured to output light to the region (space) between the partial transmission plate and the total reflection mirror 140. With this configuration, the light output from the light sources 160 is repeatedly reflected between the total reflection mirror 140 and the partial transmission plate, and every time the light is incident on the partial transmission plate, the portion of the light is transmitted through the partial transmission plate in the direction from the lower surface to the upper surface, thereby forming an infinity mirror image. By switching the voltage applied to the liquid crystal layer 126 of the liquid crystal display portion 120, it is possible to switch between the transmission state in which the infinity mirror image can be displayed and the non-transmission state in which the infinity mirror image is not displayed.

Therefore, it is possible to provide the display apparatuses 100 and 100A to 100G configured to switch the infinity mirror image not to be displayed.

Also, since the light sources 160 are disposed outside the switchable region 120A in a plan view in the display apparatuses 100 and 100A to 100G, the size of the region outside the switchable region 120A can be desirably set in accordance with the size of the light sources 160. Since the light sources 160 can be disposed inside the outer periphery of the liquid crystal display portion 120 in a plan view, it is possible to reduce the size of the display apparatuses 100 and 100A to 100G.

Also, the partial transmission plate may be the partial reflection mirror 150. Depending on the reflectance of the partial reflection mirror 150, the light quantity due to multiple reflections repeated between the total reflection mirror 140 and the partial reflection mirror 150 can be set, and the intensity of display of an infinity mirror image can be set.

Also, the liquid crystal display portion 120 may include the liquid crystal layer 126, the glass plate 124 provided on the first side (+Z direction side) opposite to the partial reflection mirror 150 across the liquid crystal layer 126, the glass plate 122 provided on the second side (−Z direction side) opposite to the first side across the liquid crystal layer 126, the pair of the electrodes 1 (first electrodes), and the pair of the electrodes 2 (second electrodes). The pair of electrodes 1 may be connected to each other to have the same potential, and may be provided over the glass plates 124 and 122 on a one-by-one basis. The pair of electrodes 2 may be connected to each other to have the same potential, and may be provided over the glass plates 124 and 122 on a one-by-one basis. The electrode 1 of the glass plate 124 and the electrode 2 of the glass plate 122 may overlap with each other at the centers of the glass plates 124 and 122 in a plan view, and the pair of the electrodes 1 may overlap with each other and the pair of the glass plates 122 may overlap with each other at the portions outside the centers of the glass plates 124 and 122 in a plan view.

At the time a voltage is applied to the liquid crystal layer 126, only the switchable region 120A becomes in the transmission state, and the infinity mirror image can be displayed. Also, without a voltage being applied to the liquid crystal layer 126, the entire liquid crystal display portion 120 including the switchable region 120A becomes in the non-transmission state, and thus all images can be non-displayed. Also, the components existing on the rear side (−Z direction side) of the liquid crystal display portion 120 can be hidden. Further, without a voltage being applied to the liquid crystal layer 126, the entire liquid crystal display portion 120 becomes in the non-transmission state, and thus all images can be non-displayed.

Also, the electrode 1 of the glass plate 124 may extend to the ends of the glass plate 124 in the first direction, and the electrode 2 of the glass plate 124 may be provided around the electrode 1 of the glass plate 124. The electrode 2 of the glass plate 122 may extend to the ends of the glass plate 122 in the second direction crossing the first direction in a plan view, and the electrode 1 of the glass plate 122 may be provided around the electrode 2 of the glass plate 122. Since the electrode 2 of the electrode 122A and the electrode 1 of the electrode 124A extend to the ends of the glass plate 122, the electrode 2 of the electrode 122A and the electrode 1 of the electrode 124A can be easily connected to the direct current-converted-to-alternating current power supply 10 outside the liquid crystal display portion 120.

The light sources 160 may be provided in a region in which the pair of the electrodes 1 of the electrodes 122A and 124A overlap with each other in a plan view, or in a region in which the pair of the electrodes 2 of the electrodes 122A and 124A overlap with each other in a plan view. The region in which the pair of the electrodes 1 of the electrodes 122A and 124A overlap with each other in a plan view and the region in which the pair of the electrodes 2 of the electrodes 122A and 124A overlap with each other in a plan view are regions in which the liquid crystal display portion 120 becomes always in the non-transmission state regardless of whether or not a voltage is applied to the liquid crystal layer 126. By disposing the light sources 160 in the regions in which the liquid crystal display portion 120 becomes always in the non-transmission state, it is possible to display an infinity mirror image with better appearance, and it is not necessary to provide any component configured to hide the light sources 160 other than the liquid crystal display portion 120, leading to a simplified configuration.

Also, the light sources 160 may be provided over the surface of the partial reflection mirror 150 on the total reflection mirror 140 side, or over the surface of the total reflection mirror 140 on the partial reflection mirror 150 side. The center axes of light emission of the light sources 160 may be inclined relative to the straight line perpendicular to the surface of the partial reflection mirror 150 on the total reflection mirror 140 side and the surface of the total reflection mirror 140 on the partial reflection mirror 150 side. The light sources 160 can be attached to the total reflection mirror 140 or the partial reflection mirror 150 without providing holders configured to hold the light sources 160. Also, when the center axes of light emission of the light sources 160 are inclined relative to the straight line parallel to the Z axis, it is possible to increase the number of multiple reflections to form an infinity mirror image with a greater depth.

Also, it may be possible to include the casing 110 (housing) configured to house the liquid crystal display portion 120, the partial reflection mirror 150, the light sources 160, and the total reflection mirror 140. The light sources 160 may be held by the holders provided over the inner surfaces of the casing 110 such that the center axes of light emission of the light sources 160 are inclined relative to the straight line perpendicular to the surface of the partial reflection mirror 150 on the total reflection mirror 140 side and the surface of the total reflection mirror 140 on the partial reflection mirror 150 side. Since the light sources 160 can be fixed to the casing 110, the light sources 160 can be provided at locations different from the locations of the total reflection mirror 140 and the partial reflection mirror 150. Also, when the center axes of light emission of the light sources 160 are inclined relative to the straight line parallel to the Z axis, it is possible to increase the number of multiple reflections to form an infinity mirror image with a greater depth.

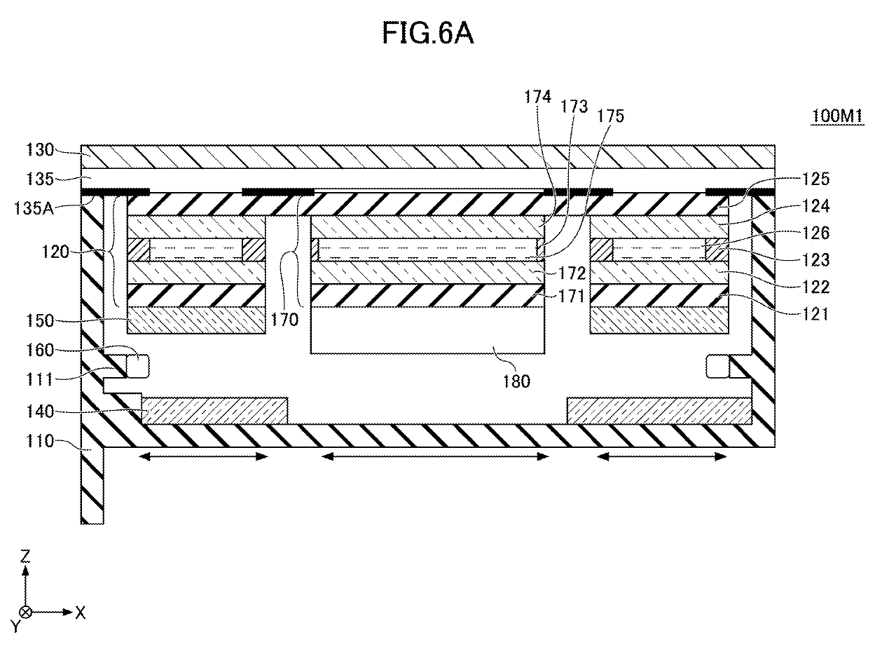

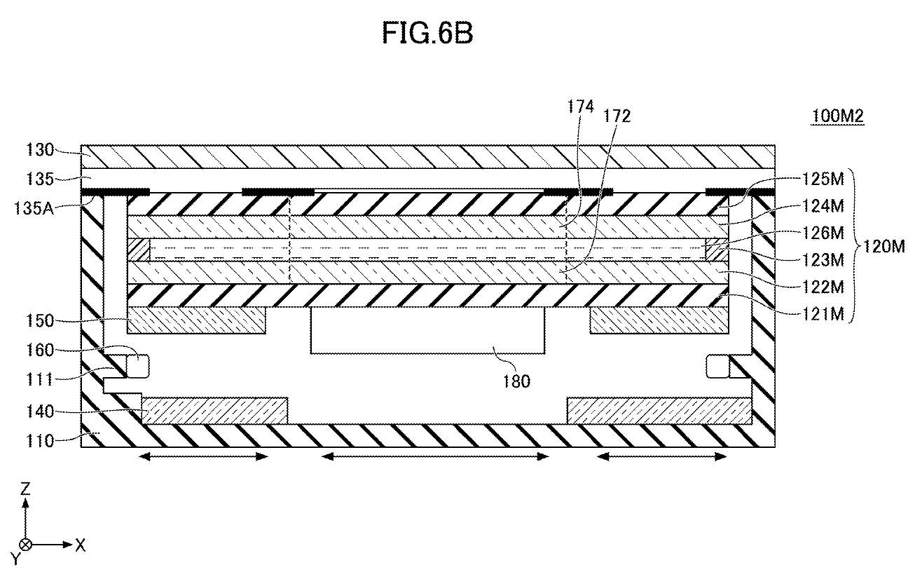

Also, it may be possible to further include a transparent protective plate disposed on the display surface side of the liquid crystal display portion 120. The protective plate may be provided with an opaque blind portion that overlaps, in a plan view, with the outer periphery of the liquid crystal display portion 120, the outer periphery of the partial reflection mirror 150, the outer periphery of the total reflection mirror 140, and the light sources 160. The blind portion provided in the protective plate can hide the outer peripheries of the liquid crystal display portion 120, the partial reflection mirror 150, and the total reflection mirror 140, as well as the light sources 160. A configuration including the protective plate will be described with reference to FIGS. 6A, 6B, 7A, and 8A to 8E.

### <Modified Examples>

FIG. 6A is a diagram illustrating an example of a cross-sectional configuration of a display apparatus 100M1 of a modified example of the embodiment. The display apparatus 100M1 includes the casing 110, the liquid crystal display portions 120, the antireflection layer 130, a protective plate 135, the total reflection mirrors 140, the partial reflection mirrors 150, the light sources 160, a liquid crystal display portion 170, and a backlight 180. The liquid crystal display portion 170 is an example of a first display portion driven by an active matrix driving method. The two liquid crystal display portions 120 are an example of a second display portion driven by a passive driving method.

The display apparatus 100M1 illustrated in FIG. 6A includes infinity mirror image regions, configured to display an infinity mirror image, on the −X direction side and the +X direction side, and an active display region at the center in the X direction. In the entire display region of the display apparatus 100M1 in a plan view, the active display region is located at the center, and the infinity mirror image display regions are located closer to the ends than the active display region is.

Here, the configuration in the XZ cross section will be described, but the display apparatus 100M1 may have the same configuration in the Y direction. Also, the display apparatus 100M1 may have the same configuration in the X direction and the Y direction. That is, the display apparatus 100M1 may include the active display region disposed at the center in a plan view and the infinity mirror image regions disposed around the active display region.

The configuration of the infinity mirror image region of the display apparatus 100M1 is the same as the configuration of the display apparatus 100 illustrated in FIG. 1, but is different in the following point. In the display apparatus 100M1, the antireflection layer 130 is provided over the upper surface of the protective plate 135.

The protective plate 135 is a transparent glass or resin plate (a cover glass or resin). Being “transparent” refers to transmitting light. The protective plate 135 includes decorative layers 135A over the side walls of the casing 110, the outer peripheries of the liquid crystal display portions 120, and the lower surfaces of portions, of the protective plate 135, corresponding to the boundaries between the liquid crystal display portion 170 and the liquid crystal display portions 120. The decorative layers 135A are the black decorative layers 135A configured to hide the side walls of the casing 110, the outer peripheries of the liquid crystal display portions 120, and the boundaries between the liquid crystal display portions 120 and the liquid crystal display portion 170.

The casing 110, the polarizing plate 125, and the antireflection layer 130 are shared by the two infinity mirror image regions and the single active display region.

The liquid crystal display portion 120, the antireflection layer 130, the total reflection mirror 140, the partial reflection mirror 150, and the light source 160 are provided in each of the infinity mirror image regions.

The liquid crystal display portion 170 and the backlight 180 are provided in the active display region. The liquid crystal display portion 170 includes a polarizing plate 171, a glass plate 172 over which a TFT (Thin Film Transistor) is formed, a sealing seal 173, a glass plate 174 over which a color filter is formed, a polarizing plate 125, and a liquid crystal layer 175.

The polarizing plate 171, the glass plate 172, the sealing seal 173, the glass plate 174, and the polarizing plate 125 are provided in this order from the lower side to the upper side. The liquid crystal layer 175 is sealed in a space enclosed by the sealing seal 173, having a rectangular ring shape in a plan view, and the glass plates 172 and 174.

The backlight 180 is an edge-type backlight, and attached to the underside of the polarizing plate 171. The backlight 180 includes a light guide configured to guide, in the +Z direction, light output from the light source provided at the −X direction-side end, the +X direction-side end, the −Y direction-side end, or the +Y direction-side end. The backlight 180 illuminates the liquid crystal display portion 170 from the −Z direction side.

The liquid crystal display portion 170 can display various images, such as still images, moving images, and the like, in the active display region by driving the TFT formed over the glass plate 172 by an active matrix method.

Therefore, the display apparatus 100M1 can display various images in the active display region, and display an infinity mirror image in the infinity mirror image display regions.

As described above for the display apparatus 100M1, the liquid crystal display portion includes the first display portion (the liquid crystal display portion 170) driven by the active matrix driving method, and the second display portions (the liquid crystal display portions 120) driven by the passive driving method. The partial reflection mirrors 150 may be provided on the rear sides of the second display portions (the liquid crystal display portions 120). The active matrix driving method can provide the display apparatus 100M1 configured to display various images, such as still images, moving images, and the like, and switch an infinity mirror image not to be displayed in the second display portions. The light sources 160 may be provided on the inner wall or the like of the casing 110 without providing the projections 111.

Note that, instead of the liquid crystal display portion 170 and the backlight 180, liquid crystal display portions 220, 220D, and 220E of display apparatuses 200 and 200A to 200E of a second embodiment described below, and backlights 280 and 280A may be used.

### Display Apparatus 100M2 of Modified Example of Embodiment

FIG. 6B is a diagram illustrating an example of a cross-sectional configuration of a display apparatus 100M2 of a modified example of the embodiment.

The display apparatus 100M2 illustrated in FIG. 6B is different from the display apparatus 100M1 illustrated in FIG. 6A in that the display apparatus 100M2 includes a liquid crystal display portion 120M in which the two liquid crystal display portions 120 are integrated with the single liquid crystal display portion 170, as illustrated in FIG. 6A. Thus, the liquid crystal display portion 120M will be described here.

The display apparatus 100M2 illustrated in FIG. 6B includes infinity mirror image regions configured to display an infinity mirror image on the −X direction side and the +X direction side, and includes an active display region at the center in the X direction. In the entire display region of the display apparatus 100M2 in a plan view, the active display region is located at the center, and the infinity mirror image display regions are located closer to the ends than the active display region is.

Here, the configuration in the XZ cross section will be described, but the display apparatus 100M2 may have the same configuration in the Y direction. Also, the display apparatus 100M2 may have the same configuration in the X direction and the Y direction. That is, the display apparatus 100M2 may include the active display region disposed at the center in a plan view and the infinity mirror image regions disposed around the active display region.

The liquid crystal display portion 120M includes a polarizing plate 121M, a glass plate 122M, a sealing seal 123M, a glass plate 124M, a polarizing plate 125M, and a liquid crystal layer 126M. The polarizing plate 121M, the glass plate 122M, the sealing seal 123M, the glass plate 124M, the polarizing plate 125M, and the liquid crystal layer 126M are shared by the active display region and the infinity mirror image regions.

A TFT is formed in a portion of the glass plate 122M in the active display region, and a color filter is provided in a portion of the glass plate 124M in the active display region. In the active display region, it is possible to display various images by driving the liquid crystal layer 126M by the active matrix driving method.

Also, electrodes configured to achieve the switchable region 120A are formed in portions of the glass plates 122M and 124M in the infinity mirror image display regions, and can switch the liquid crystal layer 126M in the infinity mirror image display regions between a transmission state and a non-transmission state. When the liquid crystal layer 126M in the infinity mirror image display regions is switched to be in the transmission state, it is possible to display an infinity mirror image.

As described above, the liquid crystal display portion 120M includes the first display region (the active display region) driven by the active matrix driving method and the second display regions (the infinity mirror image display regions) driven by the passive driving method, and the partial reflection mirrors 150 may be provided on the rear side of the second display regions. The active matrix driving method can provide the display apparatus 100M2 configured to display various images, such as still images, moving images, and the like, and switch an infinity mirror image not to be displayed in the second display portions. Also, the first display region (the active display region) and the second display regions (the infinity mirror image display regions) can be displayed in the single liquid crystal display portion 120M.

The liquid crystal display portions 220, 220D, and 220E and the backlights 280 and 280A of the display apparatuses 200 and 200A to 200E of the second embodiment described below may be used instead of the portion of the liquid crystal display portion 120M in the active display region and the backlight 180. The light sources 160 may be provided on the inner wall or the like of the casing 110 without providing the projections 111.

### <Second Embodiment>

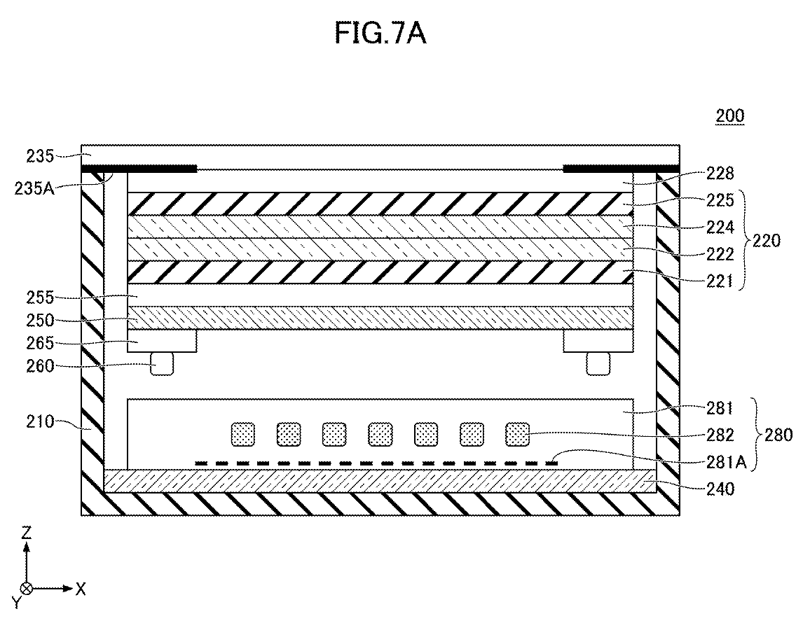

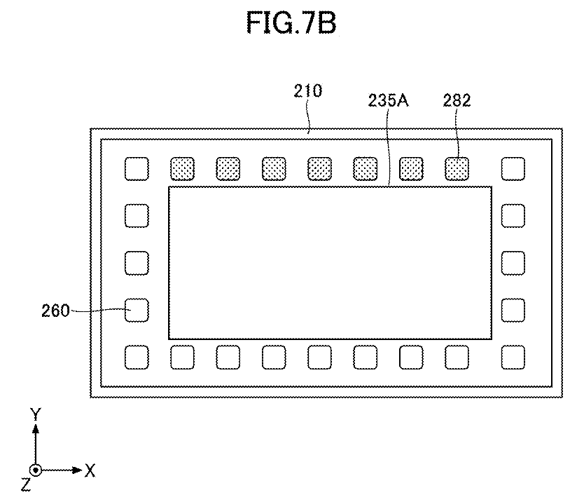

FIG. 7A is a diagram illustrating an example of a cross-sectional configuration of a display apparatus 200 of the second embodiment. The display apparatus 200 includes a casing 210, a liquid crystal display portion 220, a protective plate 235, a total reflection sheet 240, a partial reflection sheet 250, a light diffusion sheet 255, light sources 260, substrates 265, and a backlight 280. The partial reflection sheet 250 is an example of the partial transmission plate and an example of the partial reflection mirror. The light source 260 is an example of the first light source.

The casing 210 and the light sources 260 are the same as the casing 110 and the light sources 160 of the display apparatus 100 of the first embodiment (see FIG. 1).

The protective plate 235 is the same as that of the display apparatus 100M1 (see FIG. 6A) of the modified example of the embodiment. The total reflection sheet 240 and the partial reflection sheet 250 are sheet members of the total reflection mirror 140 and the partial reflection mirror 150 of the display apparatus 100 (see FIG. 1) of the first embodiment. The display apparatus 200 does not include the antireflection layer 130 (see FIG. 1) but can include the antireflection layer 130. The upper surface of the protective plate 235 is a display surface of the display apparatus 200.

The components of the display apparatus 200 of the second embodiment will be described below, focusing on differences from the display apparatus 100 of the first embodiment. The display apparatus 200 of the second embodiment is the same as the display apparatus 100 of the first embodiment in that the display apparatus 200 can display an infinity mirror image.

### <Casing 210>

The casing 210 is a housing of the display apparatus 200. The casing 210 has, as an example, a box shape, and a rectangular shape in a plan view. The casing 210 includes an opening at an upper portion, and an inner space communicating with the opening and spreading downward. Such an inner space is an example of a region, and more specifically, an example of a three-dimensional region. The total reflection sheet 240 is disposed at the bottom of the inner space of the casing 210, and the protective plate 235 is provided in the upper opening. Also, the inner space of the casing 210 may be sealed, for example, with a transparent resin. The portion of the inner space sealed with the transparent resin is a three-dimensional region inside the casing 210.

### <Liquid Crystal Display Portion 220>

As an example, the liquid crystal display portion 220 is bonded to the lower surface of the protective plate 235 with an OCA (Optical Clear Adhesive) 228. An OCR (Optical Clear Resin) may be used instead of the OCA 228.

The liquid crystal display portion 220 includes a polarizing plate 221, a glass plate 222, a glass plate 224, and a polarizing plate 225. FIG. 7A omits illustration of the sealing seal 123 and the liquid crystal layer 126 illustrated in FIG. 1. The glass plate 224 is an example of the first glass plate, and the glass plate 222 is an example of the second glass plate.

As an example, the liquid crystal display portion 220 is a liquid crystal display portion driven by the active matrix driving method. Therefore, a TFT is formed over the upper surface of the glass plate 222, and a color filter is provided over the lower surface of the glass plate 224. The liquid crystal display portion 220 driven by the active matrix driving method can display various images, such as still images, moving images, and the like. Since the configuration and operation of the liquid crystal display portion 220 are the same as those of the liquid crystal display portion 170 illustrated in FIG. 6A, detailed description thereof will be omitted.

The protective plate 235 is a transparent glass or resin plate (a cover glass or resin). Being “transparent” refers to transmitting light. In a plan view, the protective plate 235 includes decorative layers 235A over the outer peripheries of the OCA 228, the liquid crystal display portion 220, the light diffusion sheet 255, and the partial reflection sheet 250, and at portions where the light sources 260 and the substrates 265 are located. The decorative layers 235A are provided over the lower surface of the protective plate 235, and are black decorative layers configured to hide the outer peripheries of the OCA 228, the liquid crystal display portion 220, the light diffusion sheet 255, and the partial reflection sheet 250, as well as the light sources 260 and the substrates 265. The decorative layers 235A have a rectangular ring shape in a plan view, and the inner periphery of the decorative layer 235A is located inside the periphery of the below-described substrate 265 closer to the center.

### <Total Reflection Sheet 240>

The total reflection sheet 240 is provided at the bottom of the inner space of the casing 210, and the upper surface of the total reflection sheet 240 is a reflective surface configured to totally reflect light. The total reflection sheet 240 is a sheet of the total reflection mirror 140 of the first embodiment, and functions as a total reflection mirror. As an example, the total reflection sheet 240 can be produced by depositing aluminum on the upper surface of a sheet member. The total reflection sheet 240 is not limited to such a configuration, and may have any configuration as long as it has an upper surface that is a reflective surface configured to totally reflect light. The total reflection mirror 140 of the first embodiment may be used instead of the total reflection sheet 240.

### <Partial Reflection Sheet 250>

The partial reflection sheet 250 is attached to the lower surface of the liquid crystal display portion 220 via the light diffusion sheet 255. The partial reflection sheet 250 is a sheet of the partial reflection mirror 150 of the first embodiment, and functions as a partial reflection mirror. As an example, the light transmittance of the partial reflection sheet 250 may be set to an appropriate value from about 20% to about 80%, and more preferably may be set to an appropriate value from about 30% to about 70%. Here, as an example, the light transmittance of the partial reflection sheet 250 is assumed to be 50%.

The partial reflection sheet 250 transmits light coming from below, from the lower surface toward the upper surface, and reflects the remaining light downward at the lower surface.

Here, instead of the partial reflection sheet 250, the partial reflection mirror 150 (see FIG. 1) of the first embodiment may be used, or the hard coat 150A of the display apparatus 100A (see FIG. 4A) of the modified example of the embodiment may be used.

### <Light Diffusion Sheet 255>

The light diffusion sheet 255 is a sheet configured to diffuse incident light, and for example, an LED diffusion sheet may be used. As an example, the light diffusion sheet 255 has adhesiveness. Therefore, the partial reflection sheet 250 can be attached to the lower surface of the polarizing plate 221 of the liquid crystal display portion 220 via the light diffusion sheet 255. By providing the light diffusion sheet 255, light can be sufficiently scattered below the liquid crystal display portion 220, thereby displaying an infinity mirror image.

### <Light Sources 260>

As an example, the light sources 260 are attached to the lower surfaces of the substrates 265, which are attached to the lower surface of the partial reflection sheet 250. The light source 260 is, as an example, an LED, but may be a light emitter other than an LED. The light source 260 outputs light into a space (region) between the partial reflection sheet 250 and the total reflection sheet 240.

Here, the arrangement of the light sources 260 will be described with reference to FIG. 7B in addition to FIG. 7A. FIG. 7B is a diagram illustrating an example of a positional relationship, in a plan view, between the light sources 260 and light sources 282. FIG. 7B also illustrates side walls of the casing 210 and an inner periphery of the decorative layer 235A.

The light sources 260 are provided along three of the four side walls of the casing 210 at equal intervals in a plan view. The three side walls of the casing 210 are, for example, a side wall extending in the Y direction on the −X direction side, a side wall extending in the X direction on the −Y direction side, and a side wall extending in the Y direction on the +X direction side.

The center axes of light emission of the light sources 260 are inclined relative to the straight line perpendicular to the lower surface of the partial reflection sheet 250 and the upper surface of the total reflection sheet 240 (the straight line parallel to the Z axis). More specifically, the center axes of light emission of the light sources 260 are designed, as an example, to face obliquely downward toward the center of the light guide 281 of the backlight 280. By inclining the center axes of light emission of the light sources 260 relative to the straight line perpendicular to the lower surface of the partial reflection sheet 250 and the upper surface of the total reflection sheet 240 (the straight line parallel to the Z axis), light is obliquely incident on the total reflection sheet 240 and the partial reflection sheet 250, thereby increasing the number of multiple reflections and obtaining an infinity mirror image with a greater depth.

### <Substrates 265>

The substrates 265 are provided over the lower surface of the partial reflection sheet 250 along the above-described three side walls of the casing 210. As an example, the substrates 265 are adhered to the lower surface of the partial reflection sheet 250 with a transparent adhesive, such as an OCA. In an XZ cross-sectional view, the widths of the substrates 265 in the X direction are larger than those of the light sources 260, and both ends of the substrates 265 in the X direction are located outside the light sources 260. The same applies to a YZ cross-sectional view of a section in which the light sources 260 are provided along the X direction on the −Y direction side. That is, the widths of the substrates 265 in the Y direction are larger than those of the light sources 260, and both ends of the substrates 265 in the Y direction are located outside the light sources 260.

The substrates 265 for use can be, as an example, a wiring substrate, such as a PWB (Printed Wiring Board), an FPC (Flexible Printed Circuit), or the like. A terminal of each of the light sources 260 is connected to an external device of the display apparatus 200, for example, via the interconnect of the substrate 265, and further, for example, via an interconnect or the like (not shown). Lighting control of each light source 260 is performed by the external device, as an example.

### <Backlight 280>

The backlight 280 is an edge-type backlight, and is attached to the upper surface of the total reflection sheet 240. The backlight 280 includes the light guide 281 and the light sources 282. The light sources 282 are an example of the second light source. The backlight 280 is located on the −Z direction side of the light sources 260.

The light guide 281 is provided over substantially the entire surface of the total reflection sheet 240. A light guide pattern 281A configured to reflect light upward is provided in a center portion of the lower surface of the light guide 281 excluding both ends in the X and Y directions. The light guide pattern 281A is, for example, minute recesses and projections provided in the lower surface of the light guide 281, or a film coated with a material that reflects light.

The light sources 282 are, as an example, an LED, but may be a light emitter other than an LED. As illustrated in FIG. 7B, the light sources 282 are, as an example, provided toward the −Y direction side near the bottom of the side wall extending in the X direction on the +Y direction side, among the four side walls of the casing 210. The light sources 282 are disposed along the side wall extending in the X direction on the +Y direction side of the casing 210, specifically, disposed in a section excluding the −X direction-side end and the +X direction-side end. This is for avoiding overlapping, in a plan view, with the light sources 260 disposed at the +Y direction-side ends, among the light sources 260 on the −X direction side and the +X direction side.

For allowing an infinity mirror image to be easily visible, the light sources 282 are provided along the side walls extending in the X direction on the +Y direction side of the casing 210 and disposed in the section excluding the −X direction-side end and the +X direction-side end, i.e., the light sources 282 are disposed at positions not overlapping with the light sources 260 in a plan view. When display of the infinity mirror image is not influenced, the light sources 282 of the backlight 280 may be provided at positions overlapping with the light sources 260 in a plan view.

In the display apparatus 200, when the light sources 260 and the light sources 282 of the backlight 280 are turned on, and the liquid crystal display portion 220 displays an image, the image of the liquid crystal display portion 220 is displayed in a rectangular display region enclosed by the decorative layer 235A of the protective plate 235.

Also, since the center axes of light emission of the light sources 260 are inclined relative to the straight line perpendicular to the partial reflection sheet 250 and the total reflection sheet 240 (the straight line parallel to the Z axis), light is obliquely incident on the total reflection sheet 240 and the partial reflection sheet 250. This increases the number of multiple reflections between the total reflection sheet 240 and the partial reflection sheet 250, and thus an infinity mirror image is displayed at the −X direction-side end, the −Y direction-side end, and the +X direction-side end of the rectangular display region of the protective plate 235 enclosed by the decorative layer 235A. The −X direction-side end, the −Y direction-side end, and the +X direction-side end of the rectangular display region enclosed by the decorative layer 235A are positions corresponding to the three side walls of the casing 210 in which the light sources 260 are provided.

As described above, the display apparatus 200 of the second embodiment can display an infinity mirror image. More specifically, the display apparatus 200 of the second embodiment can display an image of the liquid crystal display portion 220 in the center region of the rectangular display region of the protective plate 235 enclosed by the decorative layer 235A, and can display the infinity mirror image around the center region.

### Display Apparatuses 200A to 200E of Modified Examples of Second Embodiment

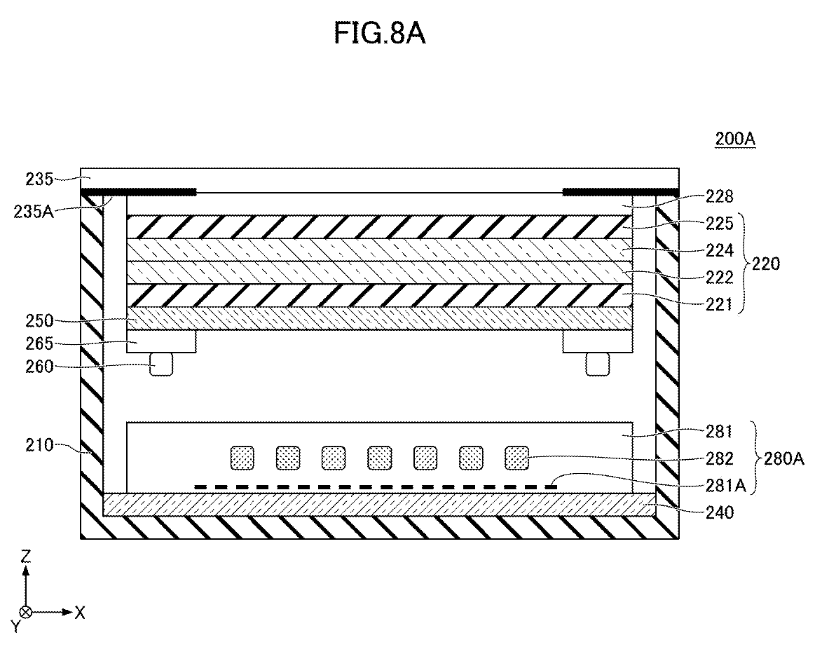

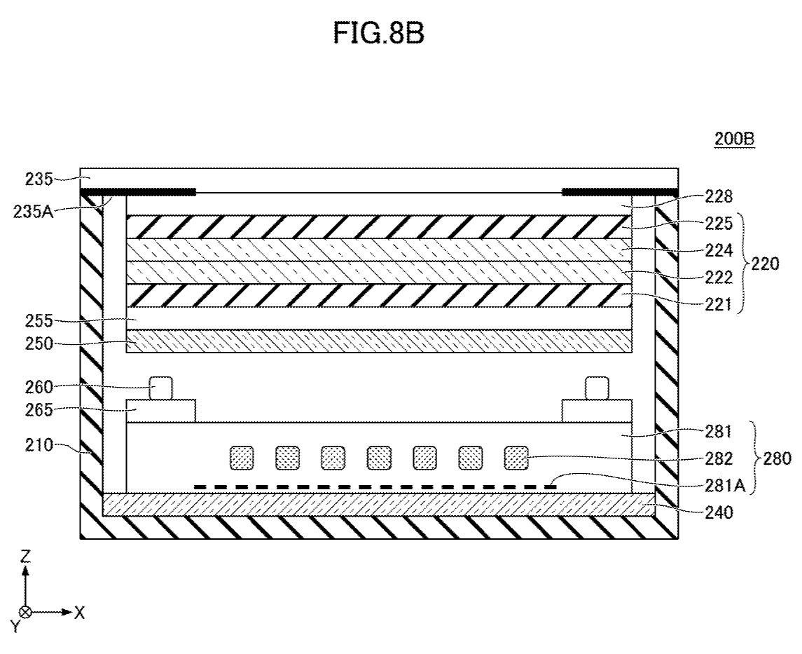

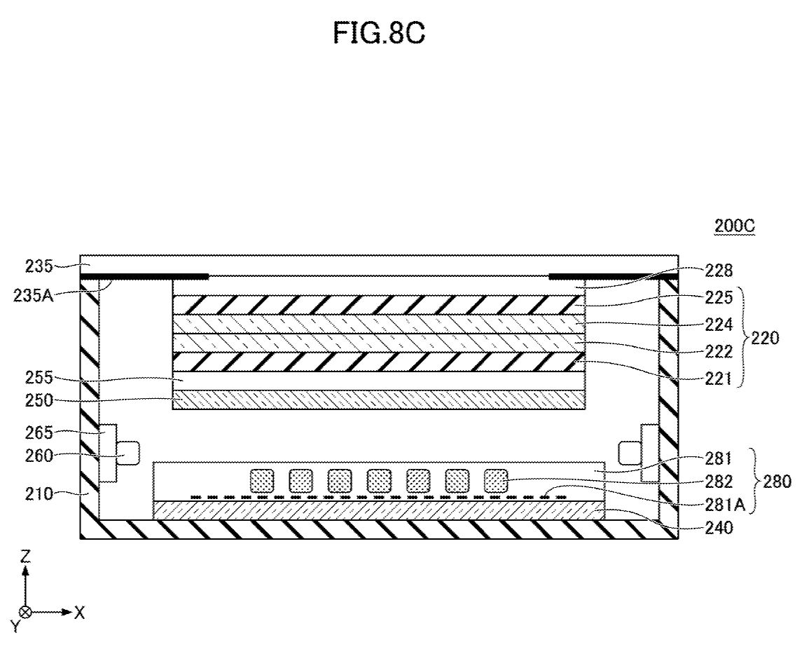

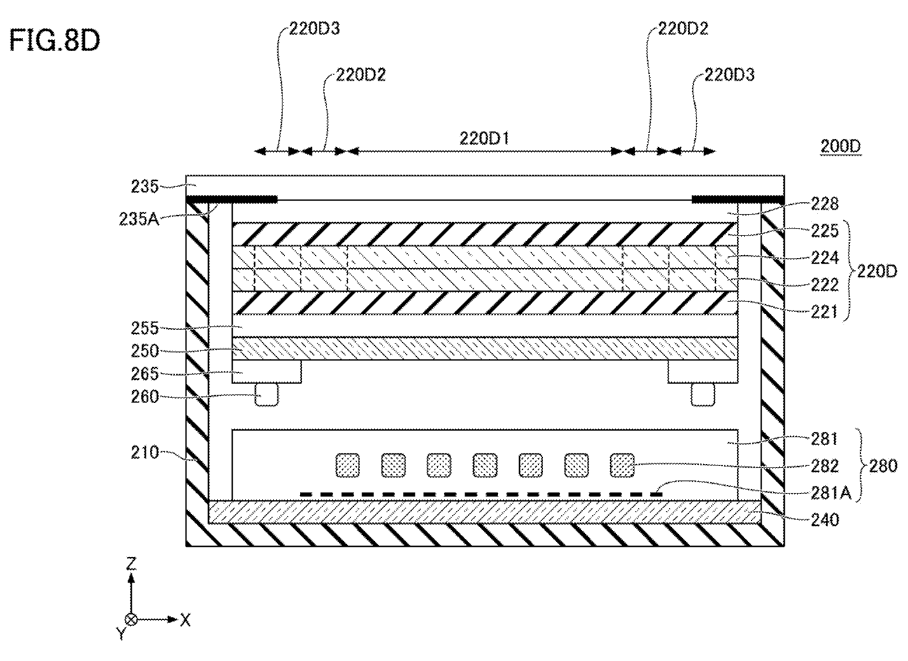

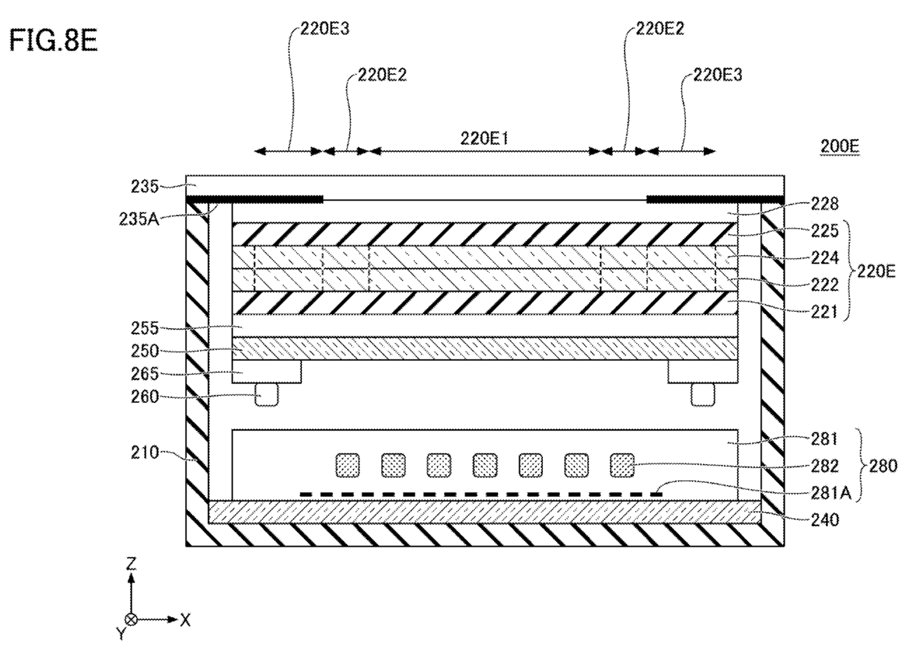

FIGS. 8A to 8E are cross-sectional diagrams illustrating examples of configurations of display apparatuses 200A to 200E of modified examples of the second embodiment. FIGS. 8A to 8E illustrate cross-sectional configurations in the XZ plane corresponding to the display apparatus 200 illustrated in FIG. 7A. The same components as the components of the display apparatus 200 illustrated in FIG. 7A are denoted by the same reference signs, and description thereof is omitted.

### <Display Apparatus 200A>

A display apparatus 200A illustrated in FIG. 8A has a configuration the same as the configuration of the display apparatus 200 illustrated in FIG. 7A except that the light diffusion sheet 255 is not provided and a backlight 280A is included instead of the backlight 280 illustrated in FIG. 7A.

A light-transmitting material of the light guide 281 of the backlight 280A contains nanoparticles (nano-scattering materials) as an example, and thus has a light-scattering function. Therefore, even if the display apparatus 200A does not include the light diffusion sheet 255, light can be sufficiently scattered below the liquid crystal display portion 220, and thus an infinity mirror image can be displayed as in the display apparatus 200 illustrated in FIG. 7A.

### <DISPLAY APPARATUS 200B>

A display apparatus 200B illustrated in FIG. 8B has a configuration the same as the configuration of the display apparatus 200 illustrated in FIG. 7A except that the light sources 260 and the substrates 265 are moved to the upper surface of the light guide 281 of the backlight 280, and the light sources 260 are disposed upward. For example, the substrates 265 may be adhered to the upper surface of the light guide 281 with a transparent adhesive, such as an OCA.

The center axes of light emission of the light sources 260 of the display apparatus 200B are directed obliquely upward to face the center of the partial reflection sheet 250. That is, the center axes of light emission of the light sources 260 are inclined relative to the straight line perpendicular to the lower surface of the partial reflection sheet 250 and the upper surface of the total reflection sheet 240 (the straight line parallel to the Z axis). This is because light is obliquely incident on the total reflection sheet 240 and the partial reflection sheet 250, thereby increasing the number of multiple reflections and obtaining an infinity mirror image with a greater depth.

The display apparatus 200B, having the configuration in which the light sources 260 and the substrates 265 are disposed on the upper surface of the light guide 281, can display an infinity mirror image as in the display apparatus 200 illustrated in FIG. 7A.

### <Display Apparatus 200C>

A display apparatus 200C illustrated in FIG. 8C has a configuration the same as the configuration of the display apparatus 200 illustrated in FIG. 7A except that the light sources 260 and the substrates 265 are moved to the inner surfaces of the side walls of the casing 210. For example, the substrates 265 may be adhered to the side walls of the casing 210 with a transparent adhesive, such as an OCA.

As in the display apparatus 100 of the first embodiment (see FIG. 1), the center axes of light emission of the light sources 260 of the display apparatus 200C may be inclined relative to the straight line perpendicular to the lower surface of the partial reflection sheet 250 and the upper surface of the total reflection sheet 240 (the straight line parallel to the Z axis). Thus, light is obliquely incident on the total reflection sheet 240 and the partial reflection sheet 250, thereby increasing the number of multiple reflections and obtaining an infinity mirror image with a greater depth.

As an example, the center axes of light emission of the light sources 260 have an angle of about 70 degrees as an absolute value relative to the straight line perpendicular to the partial reflection sheet 250 and the total reflection sheet 240 (the straight line parallel to the Z axis). In other words, as an example, the center axes of light emission of the light sources 260 have an angle of about 20 degrees upward or downward relative to the horizontal direction. Also, light emitted from the light sources 260 radially propagates in a broad range to directly reach the total reflection sheet 240 on the lower side and directly reach the partial reflection sheet 250 on the upper side.

The display apparatus 200C, having the configuration in which the light sources 260 and the substrates 265 are disposed on the inner surfaces of the side walls of the casing 210, can display an infinity mirror image as in the display apparatus 200 illustrated in FIG. 7A. Also, in the display apparatus 200C, the light sources 260 and the substrates 265 are disposed on the inner surfaces of the side walls of the casing 210, which can reduce the distance in the Z direction between the total reflection sheet 240 and the partial reflection sheet 250. Therefore, the display apparatus 200C can be thinned compared to the display apparatus 200 (see FIG. 7A), the display apparatus 200A (see FIG. 8A), and the display apparatus 200B (see FIG. 8B).

### <Display Apparatus 200D>

A display apparatus 200D illustrated in FIG. 8D has a configuration the same as the configuration of the display apparatus 200 illustrated in FIG. 7A except that the liquid crystal display portion 220 is replaced by a liquid crystal display portion 220D.

The liquid crystal display portion 220D includes a content display region 220D1, a gradation display region 220D2, and a black display region 220D3 from the center to the outer periphery of the liquid crystal display portion 220D in a plan view. In a plan view, the content display region 220D1 has a rectangular shape, the gradation display region 220D2 has a rectangular ring shape enclosing the content display region 220D1, and the black display region 220D3 has a rectangular ring shape enclosing the gradation display region 220D2 and the content display region 220D1.

As an example, the liquid crystal display portion 220D of the display apparatus 200D has a relatively low luminance, and thus the components of the casing 210 located inside the protective plate 235 are not easily visible, e.g., the light sources 260 and the substrates 265 are not easily visible from the display surface of the display apparatus 200D. Therefore, the light sources 260 and the substrates 265 can be located inside the inner periphery of the decorative layer 235A. In other words, the inner periphery of the decorative layer 235A can be located further outside. The inner periphery of the decorative layer 235A being able to be located further outside means that the width between the inner periphery and the outer periphery of the decorative layer 235A can be reduced.

As in the case in which the luminance is relatively low, when the liquid crystal display portion 220D has a relatively high contrast, the components of the casing 210 located inside the protective plate 235 are not easily visible, e.g., the light sources 260 and the substrates 265 are not easily visible from the display surface of the display apparatus 200D. Therefore, when the liquid crystal display portion 220D has a relatively high contrast, the inner periphery of the decorative layer 235A can be located further outside, i.e., the width between the inner periphery and the outer periphery of the decorative layer 235A can be reduced.

The content display region 220D1 is a region in which various images, such as still images, moving images, and the like, can be displayed by driving a TFT provided over the upper surface of the glass plate 222 by the active matrix driving method.

The gradation display region 220D2 is a region that performs display while increasing a gradation stepwise from an inner side, closer to the content display region 220D1, to an outer side, closer to the black display region 220D3. Such a control of the gradation is referred to as a stepwise gradation control. Since the gradation display region 220D2 is a region in which an infinity mirror image is displayed, the infinity mirror image is displayed more clearly by performing the stepwise gradation control.

The black display region 220D3 is provided to overlap with the inner periphery of the decorative layer 235A in a plan view. In other words, the inner periphery of the decorative layer 235A is located inside the rectangular ring black display region 220D3 in a plan view.

The black display region 220D3 is a region in which the liquid crystal display portion 220 is displayed in black. When the display apparatus 200D is viewed from the display surface side, the black display region 220D3 displays a black color like an inwardly extended black portion of the decorative layer 235A. Also, the black display region 220D3 hides the substrates 265 and the like located inward of the inner periphery of the decorative layer 235A in a plan view. Thus, the black display region 220D3 displays the black color like the inwardly extended black portion of the decorative layer 235A, thereby hiding the substrates 265 and the like while achieving a sense of unity with the decorative layer 235A.

The display apparatus 200D is configured to display various images, such as still images, moving images, and the like, in the content display region 220D1, increase the gradation of the gradation display region 220D2 around the content display region 220D1, and clearly display an infinity mirror image. That is, the display apparatus 200D can clearly display both various images, such as still images, moving images, and the like, and the infinity mirror image.

Also, the display apparatus 200D is suitable in the case in which the luminance of the liquid crystal display portion 220D is relatively low or the contrast of the liquid crystal display portion 220D is relatively high.

### <Display Apparatus 200E>

A display apparatus 200E illustrated in FIG. 8E has a configuration the same as the configuration of the display apparatus 200 illustrated in FIG. 7A except that the liquid crystal display portion 220 is replaced by a liquid crystal display portion 220E.

The liquid crystal display portion 220E includes a content display region 220E1, a gradation display region 220E2, and a black display region 220E3 from the center to the outer periphery of the liquid crystal display portion 220E in a plan view. The content display region 220E1, the gradation display region 220E2, and the black display region 220E3 are different in size in a plan view from the content display region 220D1, the gradation display region 220D2, and the black display region 220D3 illustrated in FIG. 8D, but are the same in shape and arrangement.

The inner periphery of the decorative layer 235A is located more inside in the display apparatus 200E illustrated in FIG. 8E than in the display apparatus 200D illustrated in FIG. 8D. That is, the width between the inner periphery and the outer periphery of the rectangular ring decorative layer 235A of the display apparatus 200E illustrated in FIG. 8E is larger than the width between the inner periphery and the outer periphery of the decorative layer 235A of the display apparatus 200D illustrated in FIG. 8D.

As an example, the liquid crystal display portion 220E of the display apparatus 200E has a relatively high luminance, and thus the components of the casing 210 located inside the protective plate 235 are easily visible, e.g., the light sources 260 and the substrates 265 are easily visible from the display surface of the display apparatus 200E. Therefore, if the light sources 260 and the substrates 265 are located inside the inner periphery of the decorative layer 235A, there is a possibility that the light sources 260 and the substrates 265 are visible. Thus, the inner periphery of the decorative layer 235A is preferably located further inside.

As in the case in which the luminance is relatively high, when the liquid crystal display portion 220E has a relatively low contrast, the components of the casing 210 located inside the protective plate 235 are easily visible, e.g., the light sources 260 and the substrates 265 are easily visible from the display surface of the display apparatus 200E. Therefore, when the liquid crystal display portion 220E has a relatively low contrast, the inner periphery of the decorative layer 235A is preferably located further inside. For this reason, the width between the inner periphery and the outer periphery of the rectangular ring decorative layer 235A of the display apparatus 200E is larger than the width between the inner periphery and the outer periphery of the decorative layer 235A of the display apparatus 200D illustrated in FIG. 8D.

The roles of the content display region 220E1, the gradation display region 220E2, and the black display region 220E3 are the same as the roles of the content display region 220D1, the gradation display region 220D2, and the black display region 220D3 illustrated in FIG. 8D. However, due to the difference in the width of the decorative layer 235A, the content display region 220E1, the gradation display region 220E2, and the black display region 220E3 are configured as follows.

Similarly to the content display region 220D1, the content display region 220E1 can display various images, such as still images, moving images, and the like, by the active matrix driving method. However, the content display region 220E1 is slightly smaller than the content display region 220D1.

Similarly to the gradation display region 220D2, the gradation display region 220E2 is a region that clearly displays an infinity mirror image by performing the stepwise gradation control. However, the outer periphery of the gradation display region 220E2 substantially coincides with the inner periphery of the decorative layer 235A. The stepwise gradation control is preferably performed such that the change in the gradation takes as continuous values as possible, i.e., the gradation changes smoothly.

Similarly to the black display region 220D3, the black display region 220E3 displays a black color. However, the black display region 220E3 is provided at a position overlapping with the decorative layer 235A.

When the liquid crystal display portion 220E has a high luminance or a low contrast, the components located inside the casing 210, such as the light sources 260, the substrates 265, and the like, are easily visible. For reliably hiding these components, the positions of the gradation display region 220E2 and the black display region 220E3, and the width of the decorative layer 235A are adjusted as described above, as an example.

The above description has been made based on the configuration in which, for hiding the internal components, the width of the decorative layer 235A is increased and the black display region 220E3 and the decorative layer 235A are adjusted to overlap with each other. However, the positions of the gradation display region 220E2 and the black display region 220E3 and the width of the decorative layer 235A can be adjusted in consideration of the gradation of the gradation display region 220E2, the black gradation of the black display region 220E3, the appearance of the internal components, and the like.

The display apparatus 200E is configured to display various images, such as still images, moving images, and the like, in the content display region 220E1, increase the gradation of the gradation display region 220E2 around the content display region 220E1, and clearly display an infinity mirror image. That is, the display apparatus 200E can clearly display both various images, such as still images, moving images, and the like, and the infinity mirror image.

Also, the display apparatus 200E is suitable in the case in which the luminance of the liquid crystal display portion 220E is relatively high or the contrast of the liquid crystal display portion 220E is relatively low.

### <Measurement Examples of Gradation Control>

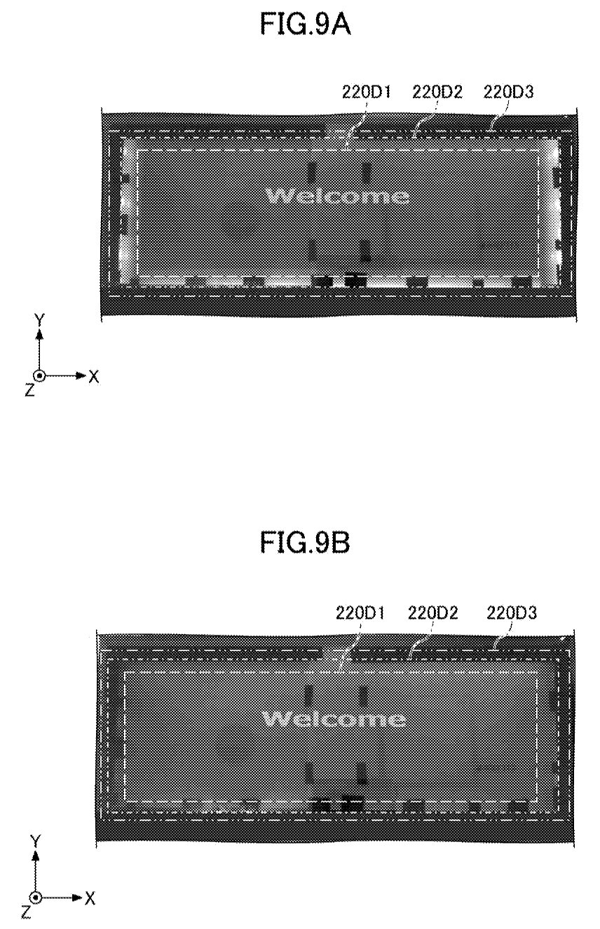

FIGS. 9A and 9B are diagrams illustrating a measurement example of gradation control in the display apparatus 200D. FIGS. 9A and 9B illustrate a state of being displayed in the display region (inside the inner periphery of the decorative layer 235A) of the protective plate 235 of the display apparatus 200D. The gradation of the liquid crystal display portion 220D can be controlled in 256 gradations for each of RGB as an example, and the brightest (thinnest) gradation is L255 and the darkest (thickest) gradation is L0.

In FIGS. 9A and 9B, the content display region 220D1 is shown by a broken line, the gradation display region 220D2 is shown by a dash-dot line, and the black display region 220D3 is shown by a dash-double-dot line.

In FIGS. 9A and 9B, an image in which the letter “Welcome” is disposed at the center of a black background is displayed on the liquid crystal display portion 220, and the gradations of the content display region 220D1, the gradation display region 220D2, and the black display region 220D3 were set as follows.

FIG. 9A illustrates a state in which the light sources 260 are turned on (lit), the backlight 280 is turned on (lit), and the gradation of the background image in the content display region 220D1 was set to L7 (the eighth gradation from L0). In FIG. 9A, the gradation of the gradation display region 220D2 is set to L7 at the inner end and to L255 at the outer end by performing the stepwise gradation control. The gradation of the black display region 220D3 was set to L0 (black).

FIG. 9B illustrates a state in which the light source 260 is turned off (unlit), the backlight 280 is turned on (lit), and the gradation of the image in the content display region 220D1 is set to L7 (the eighth gradation from L0). In FIG. 9B, the gradation of the gradation display region 220D2 was set to L7 without performing the stepwise gradation control. The gradation of the black display region 220D3 was set to L0 (black).

As understood by comparing FIGS. 9A and 9B, it was confirmed that the infinity mirror image could be clearly displayed by performing the stepwise gradation control in the content display region 220D1 (see FIG. 9A) compared to the stepwise gradation control not being performed (FIG. 9B). It was also confirmed that the infinity mirror image could be clearly displayed when the gradation of the image in the content display region 220D1 was set to L7, the innermost side of the gradation display region 220D2 was set to L7, and the outermost side of the gradation display region 220D2 was set to L0.

### <Effects>

The display apparatus 200 includes the liquid crystal display portion 220, the partial transmission plate (the partial reflection sheet 250) provided on the rear side of the liquid crystal display portion 220, and the total reflection mirror (the total reflection sheet 240) provided opposite to the liquid crystal display portion 220 across the partial transmission plate and facing the partial transmission plate with a space being between the total reflection mirror and the partial transmission plate. The display apparatus 200 includes the first light source (the light sources 260) having the center axis of light emission directed to the partial transmission plate or the total reflection mirror and configured to output light into a region (the space) between the partial transmission plate and the total reflection mirror, and the edge-type backlight (the backlight 280) including the second light source (the light sources 282) and the light guide 281 configured to guide light output from the second light source, the edge-type backlight being provided closer to the total reflection mirror than to the light sources 260. Therefore, multiple reflections of a reflected imaginary image are achieved between the partial transmission plate and the total reflection mirror, and an infinity mirror image can be displayed.

Therefore, it is possible to provide the display apparatus 200 configured to display an infinity mirror image.

Also, the partial transmission plate may be a partial reflection mirror (the partial reflection sheet 250). Depending on the reflectance of the partial reflection mirror (the partial reflection sheet 250), the light quantity due to multiple reflections repeated between the total reflection mirror and the partial reflection mirror (the partial reflection sheet 250) can be set, and the intensity of display of an infinity mirror image can be set.

Also, the liquid crystal display portion 220 may include the gradation display region 220D2 configured to display a gradation image, and light output by the light sources 260 may be incident on the gradation display region 220D2. When the light of the light sources 260 is incident on the gradation display region 220D2, the infinity mirror image can be displayed in the gradation display region 220D2.

Also, the light-transmitting material of the light guide 281 may contain a nano-scattering material, or the rear surface of the light guide 281 may include minute recesses and projections. By using the backlight 280A including the light guide 281 containing the nano-scattering material or the backlight 280 including the light guide pattern 281A, the light of the backlight 280 can be scattered, and a clearer infinity mirror image can be displayed.

Also, the liquid crystal display portion 220 may be driven by the active matrix driving method. It is possible to provide the display apparatus 200 configured to display various images, such as still images, moving images, and the like, and display an infinity mirror image therearound.

The present disclosure can provide a display apparatus configured to display an infinity mirror image.

Although the illustrative display apparatuses of the embodiments of the present disclosure have been described above, the present disclosure is not limited to the specifically disclosed embodiments, and various alterations and modifications are possible without departing from the scope of the claims.

What is claimed is:

1. A display apparatus, comprising:
a liquid crystal display portion;
a partial transmission plate provided on a rear side of the liquid crystal display portion;
a total reflection mirror that is provided opposite to the liquid crystal display portion across the partial transmission plate and faces the partial transmission plate with a space between the total reflection mirror and the partial transmission plate;
a first light source that has a center axis of light emission directed to the partial transmission plate or the total reflection mirror and is configured to output light to a region between the partial transmission plate and the total reflection mirror; and
an edge-type backlight including a second light source and a light guide configured to guide light output from the second light source, wherein
the edge-type backlight is provided at a position closer to the total reflection mirror than to the first light source.

2. The display apparatus according to claim 1, wherein
the partial transmission plate is a partial reflection mirror.

3. The display apparatus according to claim 1, wherein
the liquid crystal display portion includes a gradation display region configured to display a gradation image, and
light output by the first light source is incident on the gradation display region.

4. The display apparatus according to claim 1, wherein
a light-transmitting material of the light guide contains a nano-scattering material, or
a rear surface of the light guide includes minute recesses and projections.

5. The display apparatus according to claim 1, wherein
the liquid crystal display portion is driven by an active matrix driving method.
